(19) United States
(12) Patent Application Publication
(10) Pub. No.: US 2026/0350026 A1
(43) Pub. Date: Nov. 5, 2026

(54) ARTIFICIAL INTELLIGENCE BASED THREE LEVEL HIERARCHICAL REINFORCEMENT LEARNING SYSTEM FOR ADAPTIVE DISTRIBUTED QUERY EXECUTION IN APACHE SPARK

(71) Applicant: Kanagaddi Sunil JOSHI, Pilot Point, TX (US)

(72) Inventor: Kanagaddi Sunil JOSHI, Pilot Point, TX (US)

(21) Appl. No.: 19/710,288

(22) Filed: Jun. 16, 2026

(51) Int. Cl. G06F 16/2458; G06F 9/50; G06F 16/2453; G06N 3/092

(52) U.S. Cl. CPC G06F 16/2471; G06F 9/5088; G06F 16/24544; G06F 16/24549; G06N 3/092

(57) ABSTRACT

The present invention discloses an artificial intelligence based three level hierarchical reinforcement learning system for adaptive distributed query execution in Apache Spark and method thereof. The invention comprises a query execution control device operatively coupled with an Apache Spark environment comprising a plurality of executor nodes. The query execution control device includes a query intake processor configured to receive analytical queries, a telemetry acquisition processor configured to collect runtime operational parameters from distributed computing resources, a workload characterization processor configured to generate workload representations corresponding to received analytical queries, and a hierarchical decision processor comprising a first reinforcement learning processor, a second reinforcement learning processor, and a third reinforcement learning processor arranged in a hierarchical configuration. The first reinforcement learning processor generates strategic execution directives including execution graph decomposition arrangements and join implementation selections. The second reinforcement learning processor generates adaptive resource allocation directives including executor allocation instructions, processor assignment instructions, memory reservation instructions, and cache distribution instructions.

### FIELD OF THE INVENTION

The present invention generally relates to distributed computing systems, large-scale data analytics platforms, artificial intelligence driven resource optimization systems, and cloud-native query processing architectures. More particularly, the present invention relates to an artificial intelligence based three-level hierarchical reinforcement learning system implemented as a specialized query execution device configured to adaptively optimize distributed query execution within Apache Spark environments by dynamically controlling query planning, resource allocation, and runtime task scheduling through hierarchical reinforcement learning mechanisms.

### BACKGROUND OF THE INVENTION

The exponential growth of enterprise-scale data processing has resulted in increasing reliance upon distributed computing frameworks such as Apache Spark for executing complex analytical workloads across clusters of computing nodes. Conventional Spark execution engines utilize static optimization approaches and heuristic-based scheduling mechanisms which are unable to efficiently adapt to continuously changing workload characteristics, heterogeneous cluster resources, fluctuating network conditions, and dynamic data distributions.

Existing query optimization mechanisms generally depend upon rule-based optimizers and cost models that are generated prior to query execution. Such approaches frequently produce sub-optimal execution plans when actual runtime conditions diverge from estimated conditions. Furthermore, modern distributed environments often exhibit varying node utilization, changing memory availability, network congestion, workload interference, and data skew, causing significant degradation in execution performance.

Recent machine learning approaches have attempted to improve query optimization through predictive models. However, such approaches generally operate at a single decision-making layer and fail to capture interdependencies among query planning decisions, resource management decisions, and execution scheduling decisions. Consequently, optimization opportunities across multiple operational levels remain unexplored.

There therefore exists a need for a specialized adaptive query execution device capable of continuously learning from distributed execution environments and autonomously optimizing query execution through hierarchical reinforcement learning structures operating at multiple decision layers.

Reinforcement learning has also attracted attention as a potential mechanism for improving distributed system decision-making. Unlike supervised approaches, reinforcement learning enables agents to learn optimal behaviors through interactions with their environments based upon reward feedback generated from observed outcomes. Existing reinforcement learning applications within distributed computing have explored isolated problems such as query plan optimization, resource allocation, cache management, and task scheduling. However, many of these solutions rely upon single-agent architectures designed to optimize only one aspect of the execution lifecycle. Distributed query execution inherently involves multiple interdependent decisions occurring at different temporal and operational scales. Decisions concerning query decomposition influence resource requirements, while resource availability affects scheduling effectiveness. Isolated reinforcement learning agents operating independently may therefore generate conflicting objectives that compromise overall system performance.

Flat reinforcement learning architectures also encounter scalability challenges when applied to complex distributed environments characterized by enormous state and action spaces. Large-scale Spark clusters comprise numerous executors, processing cores, storage devices, communication channels, and workload dependencies. Capturing all relevant environmental information within a single reinforcement learning model may lead to prohibitively expensive training requirements and slow convergence behavior. Moreover, single-level reinforcement learning frameworks frequently struggle to distinguish between strategic decisions requiring long-term planning and tactical decisions requiring rapid adaptation. The resulting policies may exhibit instability, suboptimal exploration behavior, and limited generalization capabilities.

Another significant drawback associated with existing optimization approaches relates to their inability to effectively exploit hierarchical structures naturally present within distributed execution workflows. Query execution processes involve multiple layers of decision-making ranging from high-level strategy formulation to low-level operational control. Strategic decisions regarding execution plans may remain relatively stable over extended durations, whereas task scheduling decisions often require millisecond-level responsiveness to runtime fluctuations. Conventional optimization frameworks rarely differentiate among these temporal characteristics, thereby limiting their ability to coordinate decisions efficiently across multiple levels of abstraction.

Energy efficiency has likewise emerged as an important consideration in modern data centers. Existing scheduling and resource allocation approaches primarily emphasize throughput and latency objectives without adequately considering energy consumption implications. The absence of integrated optimization mechanisms balancing performance and sustainability objectives may contribute to unnecessary operational costs and environmental impacts.

In view of the foregoing limitations, there exists a need for an improved technological solution capable of performing adaptive distributed query execution through coordinated optimization of strategic planning, resource management, and runtime scheduling decisions. There further exists a need for an intelligent execution framework capable of continuously learning from evolving cluster environments, accommodating heterogeneous infrastructure conditions, reducing dependence upon static heuristics and inaccurate statistical assumptions, and generating globally optimized execution policies across multiple operational layers. Such a solution should facilitate scalable decision-making, improve resource utilization efficiency, minimize execution latency, enhance fault resilience, and support autonomous adaptation within dynamic Apache Spark ecosystems.

### SUMMARY OF THE INVENTION

The present invention discloses an AI based three level hierarchical reinforcement learning system for adaptive distributed query execution in Apache Spark and method thereof. The invention comprises a specialized query execution device operatively coupled with an Apache Spark cluster. The device includes a workload observation engine, a cluster state acquisition engine, a hierarchical reinforcement learning controller, a strategic query optimization engine, a resource orchestration engine, an execution scheduling engine, a reward evaluation engine, a policy adaptation engine, a distributed telemetry repository, and a runtime execution interface.

The hierarchical reinforcement learning controller is organized into three reinforcement learning layers. A first hierarchical layer performs strategic query planning optimization by selecting execution strategies, join ordering schemes, partitioning configurations, and query decomposition structures. A second hierarchical layer performs resource allocation optimization by controlling executor deployment, memory allocation, CPU allocation, storage utilization, and network resource assignment. A third hierarchical layer performs execution scheduling optimization by dynamically controlling task placement, task migration, speculative execution decisions, and workload balancing operations.

The three reinforcement learning layers interact through hierarchical state abstraction mechanisms and reward propagation channels. Multi-level policy learning enables continuous adaptation to evolving execution environments. The device continuously observes execution outcomes and updates reinforcement learning policies through online learning mechanisms.

The invention further provides a method for adaptive distributed query execution wherein query execution decisions are generated through coordinated operation of the three hierarchical reinforcement learning layers, resulting in improved execution efficiency, reduced resource consumption, and enhanced cluster utilization.

The primary object of the present invention is to provide an AI based three level hierarchical reinforcement learning system for adaptive distributed query execution in Apache Spark and method thereof, wherein a specialized query execution device is configured to intelligently optimize distributed data processing operations through coordinated multi-level decision making.

Another object of the present invention is to provide a machine-based execution control architecture capable of dynamically adapting query execution strategies in response to continuously changing workload characteristics, cluster resource conditions, data distributions, and execution environments encountered during operation of Apache Spark clusters.

Another object of the present invention is to provide continuous learning capabilities through online reinforcement learning techniques that enable adaptation to evolving workload patterns, changing cluster topologies, varying user demands, and emerging execution scenarios without requiring extensive manual reconfiguration.

A further object of the present invention is to enhance scalability of reinforcement learning-based optimization frameworks by decomposing complex optimization problems into multiple hierarchical decision spaces, thereby reducing learning complexity and improving policy convergence characteristics.

Another object of the present invention is to provide a distributed telemetry repository capable of storing execution histories, environmental observations, policy evolution records, reward information, and workload signatures to facilitate knowledge retention and long-term optimization improvements.

Another object of the present invention is to incorporate reward evaluation mechanisms capable of simultaneously considering execution latency, throughput performance, resource efficiency, fault resilience, energy consumption, and service-level objective compliance for generating balanced optimization outcomes.

A further object of the present invention is to improve reliability and fault tolerance of distributed query execution environments by enabling adaptive execution control policies that proactively respond to node failures, execution anomalies, and resource degradation events encountered during processing operations.

Another object of the present invention is to support integration with existing Apache Spark infrastructures through standardized runtime interfaces that enable deployment of the proposed query execution device without substantial modifications to underlying distributed computing frameworks.

A further object of the present invention is to provide an intelligent execution control system capable of leveraging historical execution experiences together with real-time environmental observations for generating context-aware execution policies that continuously evolve to maximize overall cluster performance.

Yet another object of the present invention is to provide a practical and technologically advanced machine architecture for adaptive distributed query execution that addresses deficiencies associated with conventional heuristic schedulers, isolated optimization mechanisms, and non-adaptive execution frameworks employed in large-scale data analytics environments.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for adaptive distributed query execution in an Apache Spark environment using artificial intelligence based three level hierarchical reinforcement learning; and

FIG. 2 displays a flow chart for a method for adaptive distributed query execution in an Apache Spark environment using artificial intelligence based three level hierarchical reinforcement learning.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

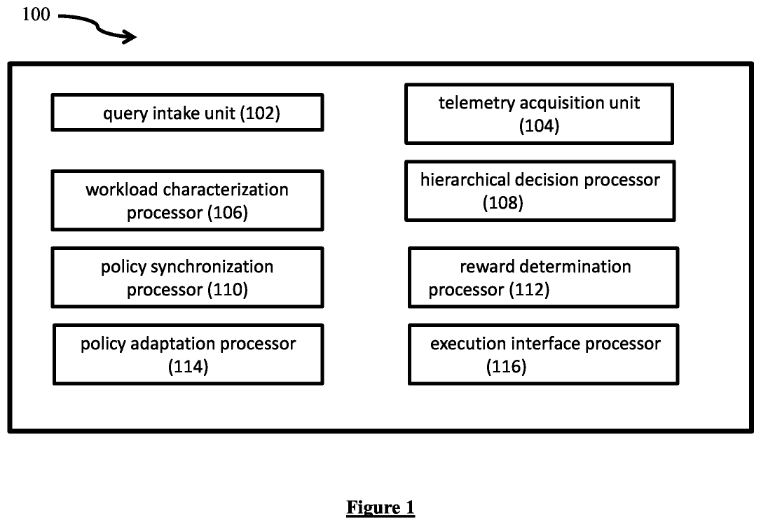

Referring to FIG. 1, a block diagram of a system for adaptive distributed query execution in an Apache Spark environment using artificial intelligence based three level hierarchical reinforcement learning is illustrated. The system 100 comprises: a query intake unit (102) configured to receive one or more distributed analytical queries originating from an Apache Spark driver associated with a plurality of executor nodes; a telemetry acquisition unit (104) operatively coupled to the plurality of executor nodes and configured to continuously collect runtime operational parameters comprising processor utilization values, memory occupancy values, cache utilization values, network transmission characteristics, storage access characteristics, task execution statistics, data locality indicators, and node availability conditions; a workload characterization processor (106) communicatively coupled to the query intake unit and configured to generate workload representations by extracting query execution graph structures, stage dependencies, partition characteristics, shuffle requirements, aggregation operations, join operation attributes, and historical execution signatures corresponding to the received analytical queries; a hierarchical decision processor (108) comprising a first reinforcement learning processor, a second reinforcement learning processor, and a third reinforcement learning processor arranged in a hierarchical configuration; wherein the first reinforcement learning processor is configured to receive the workload representations and generate strategic execution directives comprising execution graph decomposition arrangements, partition generation configurations, join implementation selections, and stage dependency ordering information; wherein the second reinforcement learning processor is configured to receive the strategic execution directives together with cluster resource conditions obtained from the telemetry acquisition unit and generate adaptive resource allocation directives comprising executor allocation instructions, processor assignment instructions, memory reservation instructions, cache distribution instructions, and storage utilization instructions; wherein the third reinforcement learning processor is configured to receive the adaptive resource allocation directives and real-time task execution conditions and generate execution scheduling directives comprising task placement decisions, workload migration decisions, speculative execution decisions, and task reprioritization decisions; a policy synchronization processor (110) configured to exchange hierarchical decision information among the first reinforcement learning processor, the second reinforcement learning processor, and the third reinforcement learning processor to maintain coordinated optimization objectives across different decision layers; a reward determination processor (112) configured to generate hierarchical reward signals corresponding to execution latency, resource utilization efficiency, task completion effectiveness, data movement overhead, and execution reliability associated with distributed query execution outcomes; a policy adaptation processor (114) configured to iteratively update reinforcement learning policies associated with the first reinforcement learning processor, the second reinforcement learning processor, and the third reinforcement learning processor using the hierarchical reward signals; and an execution interface processor (116) configured to transmit the execution scheduling directives to the Apache Spark environment for controlling adaptive execution of the analytical queries across the plurality of executor nodes.

In an embodiment, the workload characterization processor (106) is further configured to generate graph-based workload representations by converting logical query plans and physical execution plans into node-edge dependency structures, each node representing a computational operation selected from filtering operations, projection operations, aggregation operations, sorting operations, and join operations, and each edge representing execution dependencies among the computational operations, thereby enabling the first reinforcement learning processor to generate strategic execution directives based upon execution graph topology characteristics.

In an embodiment, the telemetry acquisition unit (104) further comprises a plurality of distributed monitoring processors respectively associated with the plurality of executor nodes, each distributed monitoring processor being configured to periodically capture processor queue lengths, memory page fault occurrences, cache hit ratios, disk input and output waiting durations, network packet retransmission characteristics, executor heartbeat intervals, and task retry events, and wherein the captured runtime operational parameters are transformed into multidimensional cluster state representations prior to transmission to the hierarchical decision processor.

In an embodiment, the first reinforcement learning processor comprises a strategic policy processor configured to generate alternative execution graph decomposition arrangements by selectively controlling broadcast join execution, shuffle-based join execution, partition coalescing operations, partition expansion operations, stage boundary definitions, and execution path selection, based upon historical execution outcomes associated with substantially similar workload representations stored within a telemetry storage unit.

In an embodiment, the second reinforcement learning processor is configured to generate executor allocation instructions by determining a quantity of executors assigned to individual execution stages, allocating memory capacities to respective executors according to predicted intermediate data volumes, assigning processing resources according to anticipated computational intensity, and reserving cache resources according to estimated data reuse characteristics associated with the strategic execution directives generated by the first reinforcement learning processor.

In an embodiment, the third reinforcement learning processor is configured to identify execution anomalies during runtime operation by detecting execution duration deviations exceeding dynamically learned thresholds, identifying data skew conditions associated with specific partitions, determining straggler tasks exhibiting completion characteristics different from peer tasks within a common execution stage, and generating workload migration decisions and speculative execution decisions responsive to the identified execution anomalies.

In an embodiment, further comprising a telemetry storage unit configured to maintain historical records comprising workload representations, cluster state representations, strategic execution directives, adaptive resource allocation directives, execution scheduling directives, hierarchical reward signals, and policy adaptation outcomes, wherein the policy adaptation processor is configured to retrieve the historical records for performing experience replay operations to improve convergence characteristics associated with reinforcement learning policy updates.

In an embodiment, the reward determination processor (112) is configured to generate a first hierarchical reward signal corresponding to strategic execution effectiveness determined according to reductions in execution stage dependencies and reductions in shuffle operation frequencies, generate a second hierarchical reward signal corresponding to resource allocation effectiveness determined according to processor utilization balance, memory utilization efficiency, and cache utilization characteristics, and generate a third hierarchical reward signal corresponding to scheduling effectiveness determined according to reductions in task waiting durations, reductions in straggler task occurrences, and improvements in workload distribution uniformity.

In an embodiment, the policy synchronization processor (110) is configured to perform hierarchical constraint propagation by transmitting strategic execution objectives generated by the first reinforcement learning processor to the second reinforcement learning processor, transmitting adaptive resource allocation objectives generated by the second reinforcement learning processor to the third reinforcement learning processor, and transmitting execution feedback generated by the third reinforcement learning processor to the first reinforcement learning processor, thereby maintaining consistency among decision policies associated with different hierarchical levels.

In an embodiment, the policy adaptation processor (112) is configured to selectively perform online reinforcement learning updates during active query execution and offline reinforcement learning updates using previously stored execution histories, the online reinforcement learning updates being initiated in response to changes in cluster topology, workload composition, resource contention conditions, or execution failure occurrences detected by the telemetry acquisition unit.

In an embodiment, the workload characterization processor is further configured to construct the graph-based workload representations by assigning, to each node of the node-edge dependency structures, an execution context descriptor comprising a transformation lineage identifier, an estimated intermediate dataset generation indicator, a partition affinity indicator, an execution stage membership indicator, and an operator interaction indicator, and wherein the workload characterization processor is further configured to recursively traverse parent-child dependencies within the node-edge dependency structures to identify propagation paths associated with shuffle-inducing operations, aggregate the identified propagation paths into stage-level dependency chains, determine dependency criticality scores corresponding to the stage-level dependency chains according to a quantity of downstream operations affected by execution delays occurring at individual nodes, and transmit the dependency criticality scores to the first reinforcement learning processor for prioritizing strategic execution directives associated with execution graph decomposition arrangements.

In an embodiment, the workload characterization processor is configured to generate semantically enriched graph-based workload representations capable of capturing not only the structural relationships among computational operations included within an Apache Spark execution plan, but also the execution dependencies that influence distributed processing behavior during runtime. Upon receipt of a distributed analytical query, the workload characterization processor interfaces with the Spark query planning components to obtain both logical execution plans and corresponding physical execution plans. The processor subsequently transforms the acquired plans into node-edge dependency structures represented as directed acyclic execution graphs. Each node within the execution graph corresponds to a discrete computational activity including filtering operations, mapping operations, projection operations, aggregation operations, sorting operations, join operations, repartitioning operations, window functions, user-defined transformation functions, or machine learning preprocessing operations, while edges connecting the nodes represent lineage dependencies indicating the sequence in which intermediate datasets are generated and consumed.

For each node of the node-edge dependency structures, the workload characterization processor assigns an execution context descriptor configured to capture execution attributes that influence subsequent optimization decisions performed by the hierarchical reinforcement learning architecture. The transformation lineage identifier included within the execution context descriptor uniquely represents the ancestral relationship associated with the corresponding node by preserving information regarding preceding operations responsible for generation of input datasets consumed by the node. Such transformation lineage information enables identification of computational chains extending across multiple execution stages and permits reconstruction of execution paths during runtime analysis. For example, where an analytical query includes an initial filtering operation followed by successive mapping operations, aggregation operations, and multiple join operations, the transformation lineage identifier associated with downstream nodes preserves references to upstream operations contributing to generation of intermediate outputs. Consequently, the workload characterization processor can determine whether delays arising in earlier stages propagate toward critical portions of the execution graph.

The estimated intermediate dataset generation indicator assigned to each node provides an estimate of the quantity and characteristics of intermediate datasets expected to be produced following execution of the corresponding operation. The indicator may be derived from execution statistics associated with previously executed workloads exhibiting similar structural characteristics, observed partition cardinalities collected through telemetry acquisition procedures, historical dataset growth patterns, or estimated selectivity factors associated with filtering and aggregation operations. In one exemplary implementation, a filtering operation processing customer transaction records may exhibit a substantially reduced intermediate dataset generation indicator due to elimination of irrelevant records, whereas a join operation integrating multiple transaction sources may exhibit an elevated intermediate dataset generation indicator reflective of anticipated expansion in output cardinality. Such indicators permit subsequent reinforcement learning decisions to anticipate resource requirements associated with future execution stages.

The partition affinity indicator included within the execution context descriptor specifies relationships between datasets processed by a given node and partition arrangements already existing within the distributed execution environment. More specifically, the workload characterization processor identifies whether input datasets associated with a node share common partition identifiers, equivalent partitioning functions, overlapping locality characteristics, or compatible distribution schemes. When multiple operations exhibit favorable partition affinity characteristics, the necessity for repartitioning activities and shuffle operations may be substantially reduced. Conversely, nodes associated with incompatible partition arrangements may be identified as potential sources of communication overhead requiring specialized optimization strategies. For example, where two datasets participating in a join operation are partitioned using identical customer identifiers distributed across corresponding executor nodes, the partition affinity indicator may reflect compatibility sufficient to preserve existing partition boundaries during execution.

The execution stage membership indicator identifies the execution stage to which individual nodes belong according to the physical execution plan generated within the Apache Spark environment. Such stage membership information permits grouping of nodes exhibiting common execution boundaries and facilitates subsequent evaluation of stage-level dependencies by the first reinforcement learning processor. The operator interaction indicator further characterizes relationships among neighboring nodes by identifying whether corresponding operations exhibit sequential dependencies, iterative interactions, branching behaviors, convergence patterns, or repetitive reuse of intermediate datasets. In one representative example, a downstream aggregation operation receiving outputs from multiple parallel filtering branches may be associated with operator interaction indicators identifying convergent processing characteristics requiring synchronization among upstream execution paths.

Following generation of execution context descriptors, the workload characterization processor recursively traverses parent-child dependencies within the node-edge dependency structures to identify propagation paths associated with shuffle-inducing operations. Shuffle-inducing operations represent execution activities requiring redistribution of intermediate datasets among executor nodes, thereby introducing communication overhead, disk input-output activity, and synchronization delays. The recursive traversal procedure begins by identifying nodes associated with repartitioning operations, shuffle-based join operations, global sorting operations, grouping transformations, or aggregation activities involving redistribution of data partitions. For each identified node, the workload characterization processor recursively examines descendant nodes to determine whether downstream execution activities directly depend upon completion of the shuffle-inducing operation.

During traversal, the workload characterization processor constructs propagation path representations identifying chains of dependency extending from shuffle-inducing nodes toward terminal execution nodes. Where multiple downstream operations rely upon outputs generated by a common shuffle-inducing node, branching propagation structures are generated to preserve relationships among affected execution paths. For example, a shuffle operation performed during integration of regional sales records may subsequently influence inventory forecasting operations, customer segmentation analyses, and revenue aggregation procedures occurring in later execution stages. The propagation path representation therefore captures the extent to which a single communication-intensive activity contributes to performance characteristics exhibited throughout the broader execution graph.

The identified propagation paths are subsequently aggregated into stage-level dependency chains corresponding to execution stages generated by the Spark scheduler. Each dependency chain represents a sequence of execution stages exhibiting cumulative reliance upon preceding shuffle-inducing activities. The aggregation procedure permits abstraction of complex node-level relationships into higher-level representations suitable for strategic optimization performed by the first reinforcement learning processor. In one implementation scenario involving fraud detection analytics, dependency chains may reveal that delays occurring during transaction enrichment operations propagate through risk scoring stages and ultimately affect generation of alert notifications. Recognition of such relationships enables prioritization of execution decisions affecting critical computational pathways.

The workload characterization processor further determines dependency criticality scores corresponding to the stage-level dependency chains. Such scores quantify the operational significance of execution stages according to the extent to which execution delays occurring at individual nodes influence downstream processing activities. The dependency criticality scores are generated by evaluating factors including the quantity of downstream operations dependent upon outputs generated by a particular node, the number of execution stages traversed by associated propagation paths, the anticipated computational complexity of affected downstream activities, and the estimated communication overhead attributable to delayed execution. Nodes contributing to extensive propagation effects across multiple execution stages are assigned elevated dependency criticality scores, whereas isolated nodes affecting limited downstream activities receive comparatively lower scores.

By way of illustration, consider an analytical query executing within an electronic commerce platform wherein customer browsing logs, transaction histories, inventory datasets, and recommendation models are integrated to generate personalized product suggestions. A shuffle-intensive join operation combining transaction histories with inventory datasets may support numerous downstream recommendation calculations executed across separate execution stages. The workload characterization processor identifies propagation paths extending from the join operation toward recommendation scoring stages and assigns elevated dependency criticality scores reflective of the extensive downstream impact associated with execution delays affecting the join operation. Conversely, isolated reporting operations influencing only a single downstream activity may receive lower dependency criticality scores.

The dependency criticality scores are transmitted to the first reinforcement learning processor for prioritization of strategic execution directives associated with execution graph decomposition arrangements. The first reinforcement learning processor utilizes the dependency criticality scores to distinguish execution stages warranting preferential optimization treatment from stages exhibiting comparatively limited influence on overall query performance. Strategic execution directives generated in response to elevated dependency criticality scores may include modification of stage boundaries, preservation of partition locality relationships, avoidance of unnecessary shuffle activities, or allocation of favorable execution pathways for critical execution segments. Consequently, optimization efforts become focused upon execution structures exhibiting the greatest potential influence upon distributed query performance.

Implementation of the foregoing embodiment facilitates generation of workload representations possessing substantially greater contextual richness than conventional execution graphs relying solely upon structural query information. Preservation of lineage relationships, propagation effects, partition compatibility characteristics, and stage-level dependency significance permits the hierarchical reinforcement learning architecture to formulate optimization decisions using execution-aware representations reflective of actual distributed processing dynamics. The resulting execution strategies exhibit improved responsiveness to communication bottlenecks, reduced susceptibility to propagation of delays originating from shuffle-intensive activities, enhanced prioritization of critical execution stages, and more efficient decomposition of execution graphs for distributed processing. Such improvements contribute to more predictable execution behavior, reduced processing latency, improved utilization of cluster resources, and increased robustness of adaptive query execution processes operating within large-scale Apache Spark environments.

In an embodiment, the telemetry acquisition unit is further configured to temporally align processor queue lengths, memory page fault occurrences, cache hit ratios, disk input and output waiting durations, network packet retransmission characteristics, executor heartbeat intervals, and task retry events collected from the plurality of distributed monitoring processors by assigning collection timestamps to respective runtime operational parameters, generating synchronized observation windows comprising telemetry measurements captured during common execution intervals, determining inter-node resource imbalance conditions by comparing synchronized observation windows corresponding to different executor nodes participating in a common execution stage, and generating cluster state transition representations identifying variations in resource conditions occurring between successive synchronized observation windows for transmission to the hierarchical decision processor.

In an embodiment, the telemetry acquisition unit is configured to establish a temporally coherent representation of distributed cluster behavior by collecting, aligning, and correlating runtime operational parameters generated by a plurality of distributed monitoring processors deployed across executor nodes participating in execution of analytical queries within the Apache Spark environment. In conventional distributed systems, telemetry measurements acquired independently from multiple executor nodes frequently exhibit temporal inconsistencies arising from asynchronous reporting intervals, variations in monitoring schedules, communication delays, and differences in local execution progress. Such inconsistencies may result in incomplete or misleading interpretations of cluster behavior when optimization decisions are generated using isolated measurements captured at unrelated points in time. The present embodiment addresses this challenge by constructing synchronized observation windows capable of preserving temporal relationships among operational parameters originating from different executor nodes, thereby enabling the hierarchical decision processor to formulate decisions using a unified representation of cluster conditions.

During operation, each distributed monitoring processor associated with a corresponding executor node continuously captures processor queue lengths, memory page fault occurrences, cache hit ratios, disk input and output waiting durations, network packet retransmission characteristics, executor heartbeat intervals, and task retry events generated during execution of distributed analytical workloads. Processor queue lengths may be obtained by monitoring the quantity of execution tasks awaiting processor allocation within local executor scheduling queues. Memory page fault occurrences may be recorded through observation of memory access activities resulting in retrieval of data pages from secondary storage due to absence of corresponding pages within physical memory allocations. Cache hit ratios may be determined by comparing successful cache retrieval operations against total cache access requests associated with intermediate datasets utilized during query execution. Disk input and output waiting durations may be derived from storage subsystem measurements indicating delays experienced by execution tasks awaiting completion of read or write operations. Network packet retransmission characteristics may be generated by monitoring communication activities among executor nodes and identifying instances in which data packets require repeated transmission due to communication failures or congestion conditions. Executor heartbeat intervals represent periodic status updates transmitted from executor nodes toward centralized coordination components, while task retry events identify circumstances in which execution tasks undergo repeated initiation following unsuccessful completion attempts.

The telemetry acquisition unit assigns collection timestamps to each acquired runtime operational parameter immediately upon receipt from corresponding distributed monitoring processors. In one implementation, timestamp assignment may utilize a cluster-wide synchronized time reference established through distributed clock synchronization procedures to ensure temporal consistency among geographically distributed executor nodes. The assigned collection timestamps permit preservation of chronological relationships among telemetry measurements generated throughout the execution environment. Such temporal labeling enables subsequent determination of whether distinct measurements originated during substantially identical execution intervals or whether the measurements correspond to different stages of cluster activity.

Following timestamp assignment, the telemetry acquisition unit generates synchronized observation windows comprising telemetry measurements captured during common execution intervals. The observation windows are established by grouping runtime operational parameters exhibiting collection timestamps falling within predetermined temporal boundaries corresponding to selected observation periods. The duration associated with each observation window may be dynamically adjusted according to workload characteristics, execution stage durations, or cluster activity levels. For example, workloads exhibiting rapidly changing execution characteristics may utilize shorter observation windows to improve responsiveness to transient resource fluctuations, whereas long-running analytical operations characterized by gradual resource variations may utilize comparatively larger observation windows to enhance stability of cluster state representations.

Within each synchronized observation window, telemetry measurements obtained from multiple executor nodes participating in a common execution stage are aggregated to generate temporally aligned cluster snapshots. Such snapshots capture processor utilization behaviors, memory consumption patterns, storage access characteristics, communication conditions, and task execution activities occurring contemporaneously across the distributed execution environment. Consider, for example, a large-scale retail analytics application executing customer segmentation operations involving hundreds of executor nodes distributed across a cloud computing infrastructure. During a particular synchronized observation window spanning a common execution interval, the telemetry acquisition unit may determine that a subset of executor nodes exhibits elevated processor queue lengths together with increased memory page fault occurrences, while another subset of executor nodes demonstrates comparatively low processor activity and minimal memory utilization. Because these measurements originate from equivalent execution intervals, meaningful comparisons regarding resource balance may be performed.

The telemetry acquisition unit subsequently determines inter-node resource imbalance conditions by comparing synchronized observation windows corresponding to different executor nodes participating within the same execution stage. Resource imbalance analysis may involve identification of disparities in processor queue lengths indicative of uneven workload distribution, deviations in memory page fault frequencies suggestive of inconsistent memory pressure conditions, variations in cache hit ratios reflective of differing intermediate dataset access efficiencies, differences in disk input and output waiting durations associated with storage bottlenecks, and inconsistencies in network packet retransmission characteristics indicative of localized communication congestion. Executor heartbeat intervals and task retry events may additionally be evaluated to identify executor nodes exhibiting degraded responsiveness or recurring execution instability.

For instance, during execution of a distributed fraud detection query processing millions of transaction records, synchronized observation windows may reveal that certain executor nodes consistently exhibit elevated processor queue lengths accompanied by repeated task retry events, while neighboring executor nodes maintain low processor utilization levels and stable execution behavior. Such observations indicate the presence of inter-node resource imbalance conditions potentially attributable to data skew, uneven partition assignment, or inappropriate scheduling directives. By identifying these conditions through synchronized analysis rather than isolated measurements, the telemetry acquisition unit facilitates generation of corrective actions targeting the underlying causes of execution inefficiencies.

The telemetry acquisition unit further generates cluster state transition representations identifying variations in resource conditions occurring between successive synchronized observation windows. Rather than relying solely upon instantaneous telemetry snapshots, the cluster state transition representations capture the dynamic evolution of cluster behavior throughout execution of distributed analytical workloads. Transition generation procedures involve comparison of corresponding telemetry attributes observed during consecutive observation windows to determine trends indicative of emerging bottlenecks, resource recovery patterns, or changing workload distributions. Examples of such transitions include progressive increases in processor queue lengths across specific executor groups, reductions in cache hit ratios following initiation of shuffle-intensive operations, escalating memory page fault frequencies associated with growth of intermediate datasets, or deteriorating network communication conditions resulting from increasing packet retransmission occurrences.

The cluster state transition representations may further incorporate derived transition descriptors identifying rates of change associated with monitored parameters. For example, a gradual increase in processor queue lengths accompanied by stable memory utilization may suggest accumulation of pending tasks resulting from insufficient processor allocations, whereas simultaneous increases in processor queue lengths and memory page fault occurrences may indicate resource exhaustion conditions necessitating broader resource redistribution interventions. By preserving temporal progression information, the generated cluster state transition representations enable differentiation between transient fluctuations requiring no corrective action and persistent degradation trends warranting adaptive optimization responses.

The generated cluster state transition representations are transmitted to the hierarchical decision processor for utilization during strategic execution planning, adaptive resource allocation, and runtime scheduling activities. The first reinforcement learning processor may utilize transition representations to identify execution stages exhibiting recurrent dependency-related performance degradation requiring alternative graph decomposition arrangements. The second reinforcement learning processor may exploit resource imbalance indicators to generate executor reassignment directives, modify memory reservation configurations, or revise cache allocation strategies responsive to evolving cluster conditions. The third reinforcement learning processor may employ transition information to initiate workload migration operations, adjust task placement directives, or activate speculative execution procedures in anticipation of deteriorating execution behavior.

As an illustrative example, consider execution of a recommendation analytics workload involving customer behavior modeling across a cluster comprising one hundred executor nodes. Initial synchronized observation windows may indicate balanced processor utilization and favorable cache performance. However, successive observation windows may reveal increasing memory page fault occurrences and growing processor queue lengths within executor nodes responsible for processing specific customer segments associated with disproportionately large transaction histories. The cluster state transition representations generated by the telemetry acquisition unit capture these evolving conditions and transmit corresponding information to the hierarchical decision processor. In response, adaptive resource allocation directives may redistribute executor assignments toward affected execution stages, while updated scheduling directives may subdivide workload partitions and redistribute processing activities among underutilized executor nodes. Consequently, emerging bottlenecks are addressed prior to propagation of substantial execution delays throughout the distributed processing environment.

Implementation of the present embodiment provides a temporally consistent mechanism for representing cluster behavior during execution of distributed analytical queries. The synchronized observation windows eliminate ambiguities associated with asynchronous telemetry measurements, thereby improving accuracy of inter-node comparisons. The cluster state transition representations furnish the hierarchical reinforcement learning architecture with visibility into dynamic changes occurring throughout the execution environment rather than isolated static observations. Such capabilities enable more precise identification of resource imbalance conditions, facilitate anticipation of evolving bottlenecks, improve responsiveness of adaptive optimization decisions, and support generation of execution directives aligned with actual runtime characteristics exhibited by the distributed Apache Spark infrastructure. The resulting execution environment demonstrates enhanced stability, improved resource utilization efficiency, reduced task execution variability, and increased capability to sustain predictable performance under heterogeneous and continuously changing workload conditions.

In an embodiment, the first reinforcement learning processor is further configured to generate the alternative execution graph decomposition arrangements by iteratively evaluating candidate stage boundary definitions against workload representations corresponding to received analytical queries, identifying execution stages exhibiting repeated shuffle dependencies across multiple execution paths, separating the identified execution stages into independently executable graph segments, determining whether intermediate outputs generated by upstream graph segments satisfy predetermined partition affinity conditions associated with downstream graph segments, and selectively modifying partition generation configurations prior to issuance of strategic execution directives to reduce cross-stage redistribution of intermediate datasets during distributed query execution.

In an embodiment, the first reinforcement learning processor is configured to generate alternative execution graph decomposition arrangements through an iterative decision-making process that continuously evaluates different stage organization strategies using workload representations derived from analytical queries received within the Apache Spark environment. Unlike conventional execution planning mechanisms that rely upon fixed stage boundaries established during initial query compilation, the present embodiment enables adaptive restructuring of execution graphs by considering the influence of shuffle dependencies, partition relationships, and downstream execution requirements prior to issuance of strategic execution directives. Such adaptive decomposition facilitates the generation of execution pathways that are more closely aligned with actual runtime conditions encountered within distributed computing environments.

Upon receiving graph-based workload representations generated by the workload characterization processor, the first reinforcement learning processor initiates an execution graph assessment procedure in which candidate stage boundary definitions are identified from the node-edge dependency structures. The candidate stage boundaries represent potential segmentation points within the execution graph where groups of computational operations may be organized into distinct execution stages. In one implementation, the processor initially examines dependencies among filtering operations, aggregation operations, sorting operations, repartitioning operations, and join operations to identify natural execution barriers introduced by data redistribution activities. The processor further determines whether multiple segmentation alternatives are available for a given workload representation by evaluating different combinations of stage assignments corresponding to the same underlying query structure.

The iterative evaluation process proceeds by selecting individual candidate stage boundary definitions and simulating their effects on execution behavior using workload descriptors contained within the graph-based workload representations. Such descriptors may include intermediate dataset generation characteristics, transformation lineage information, execution stage membership indicators, operator interaction relationships, and dependency criticality values previously assigned to execution nodes. During each evaluation cycle, the first reinforcement learning processor determines the extent to which a particular stage boundary arrangement influences communication requirements among executor nodes, anticipated synchronization delays, and dependencies among downstream execution stages.

Particular emphasis is placed upon identifying execution stages exhibiting repeated shuffle dependencies across multiple execution paths. Shuffle dependencies represent situations in which intermediate datasets generated by one stage require redistribution among executor nodes prior to consumption by downstream stages. Although isolated shuffle operations may be unavoidable in distributed analytical processing, repeated shuffle dependencies occurring across interconnected execution paths frequently introduce excessive network utilization, increased disk input-output activity, and elevated synchronization overhead. Consequently, the first reinforcement learning processor performs dependency tracing procedures to determine whether specific execution stages repeatedly participate in shuffle-intensive activities affecting multiple downstream execution pathways.

For example, consider an analytical workload involving customer transaction aggregation, regional inventory analysis, promotional effectiveness assessment, and recommendation generation. A conventional execution plan may perform repeated shuffle operations during integration of customer datasets with inventory datasets and again during subsequent recommendation computations. Through evaluation of execution graph structures, the first reinforcement learning processor identifies execution stages contributing to these repeated shuffle dependencies and determines that delays occurring within such stages propagate across several downstream execution paths. The processor therefore designates these stages as candidates for alternative graph decomposition arrangements.

Following identification of execution stages exhibiting repeated shuffle dependencies, the first reinforcement learning processor separates the identified execution stages into independently executable graph segments. Such separation does not merely involve arbitrary fragmentation of the execution graph but instead comprises strategic partitioning of computational activities according to dependency relationships, execution criticality characteristics, and opportunities for preserving data locality. The independently executable graph segments are generated in a manner permitting execution progress within one segment to occur without unnecessary synchronization constraints imposed by unrelated shuffle-intensive operations occurring elsewhere in the execution graph.

In one exemplary scenario involving fraud detection processing, a distributed query may comprise transaction filtering stages, account enrichment stages, behavioral aggregation stages, and anomaly scoring stages. If behavioral aggregation stages repeatedly trigger redistribution of intermediate datasets consumed by multiple anomaly scoring branches, the first reinforcement learning processor may isolate the aggregation activities into dedicated graph segments. Such segmentation enables anomaly scoring activities dependent upon completed aggregation outputs to proceed independently of unrelated computational activities occurring elsewhere within the execution graph. Consequently, execution bottlenecks associated with repeated shuffle dependencies become localized rather than propagating throughout the entire analytical workflow.

Subsequent to segmentation of the execution graph, the first reinforcement learning processor determines whether intermediate outputs generated by upstream graph segments satisfy predetermined partition affinity conditions associated with downstream graph segments. The partition affinity conditions characterize the degree to which partition arrangements established during execution of upstream graph segments remain compatible with requirements imposed by downstream processing activities. Evaluation of partition affinity involves examination of partition identifiers, partition key relationships, partition cardinality distributions, executor locality characteristics, and anticipated access patterns associated with intermediate datasets transferred between graph segments.

Where upstream and downstream graph segments exhibit favorable partition affinity characteristics, the processor determines that existing partition arrangements may be preserved without introduction of additional repartitioning activities. For instance, if transaction datasets aggregated according to customer identifiers are subsequently consumed by recommendation techniques likewise organized according to customer identifiers, the corresponding partition affinity conditions may be satisfied. In such circumstances, preservation of partition structures enables downstream graph segments to directly consume intermediate datasets generated by upstream segments while minimizing communication overhead.

Conversely, where partition affinity conditions are not satisfied, the first reinforcement learning processor selectively modifies partition generation configurations prior to issuance of strategic execution directives. Partition modification procedures may involve redefining partition boundaries, adjusting partition granularity, redistributing intermediate datasets across alternative executor node groupings, or reorganizing partition identifiers according to anticipated downstream requirements. Importantly, such modifications are performed during strategic planning stages before execution directives are propagated to subordinate reinforcement learning layers responsible for resource allocation and scheduling decisions. Consequently, subsequent execution activities are guided by partition structures specifically optimized for compatibility across multiple execution stages.

By way of illustration, consider a recommendation analytics application wherein upstream graph segments generate intermediate datasets partitioned according to geographical regions, whereas downstream graph segments performing customer recommendation computations require organization according to customer identifiers. Direct utilization of the region-based partitions would necessitate extensive shuffle operations during recommendation processing. The first reinforcement learning processor therefore modifies partition generation configurations by introducing alternative partition definitions aligned with customer identifiers prior to execution of downstream graph segments. Such modifications reduce repeated redistribution of intermediate datasets during later processing activities.

The iterative evaluation process continues across multiple candidate stage boundary definitions until execution graph decomposition arrangements exhibiting favorable performance characteristics are identified. During successive evaluation cycles, feedback obtained from previous decomposition arrangements may be utilized to refine selection of subsequent alternatives. For example, decomposition arrangements associated with excessive cross-stage communication requirements may be deprioritized during future evaluations, whereas arrangements demonstrating preservation of partition locality and reduction in shuffle propagation effects may receive increased preference during strategic decision formation.

In one practical implementation involving processing of large-scale telecommunications records, an analytical query may include call detail record filtering, subscriber profile enrichment, usage aggregation, fraud scoring, and network optimization stages. Initial decomposition arrangements generated according to conventional planning approaches may result in repeated redistribution of enriched subscriber datasets across multiple execution stages. Through iterative evaluation of alternative stage boundary definitions, the first reinforcement learning processor identifies opportunities for grouping subscriber enrichment activities with dependent fraud scoring stages while preserving partition arrangements established according to subscriber identifiers. Consequently, intermediate datasets generated during enrichment operations remain localized within executor nodes responsible for corresponding fraud analyses, thereby reducing communication overhead associated with repeated shuffling of subscriber information.

The processes described herein enable the first reinforcement learning processor to formulate execution graph decomposition arrangements responsive to workload-specific execution characteristics rather than relying exclusively upon static planning heuristics. By identifying stages associated with repeated shuffle dependencies, generating independently executable graph segments, preserving partition affinity relationships, and proactively modifying partition generation configurations where necessary, the processor produces strategic execution directives capable of improving distributed processing efficiency within Apache Spark environments. The resulting execution plans exhibit reduced cross-stage redistribution of intermediate datasets, improved utilization of executor-local data partitions, decreased synchronization delays among execution stages, and enhanced adaptability to heterogeneous workload characteristics encountered during large-scale analytical processing operations. Such improvements contribute to more efficient execution of complex distributed queries involving extensive dependency structures and dynamically evolving resource conditions.

In an embodiment, the first reinforcement learning processor is further configured to selectively control broadcast join execution and shuffle-based join execution by identifying join nodes within the workload representations, determining for each join node a degree of partition alignment between participating datasets based upon partition identifiers extracted from the workload representations, evaluating whether existing partition boundaries satisfy execution locality requirements associated with the join nodes, generating partition preservation directives responsive to satisfaction of the execution locality requirements, and alternatively generating repartitioning directives specifying partition transformation sequences to be executed before initiation of corresponding join operations.

In an embodiment, the first reinforcement learning processor is configured to selectively control broadcast join execution and shuffle-based join execution through a context-aware decision mechanism that evaluates the structural and distributional characteristics of datasets participating in join operations prior to generation of strategic execution directives. In distributed query processing environments, join operations frequently represent the most resource-intensive computational activities because they often require extensive movement of intermediate datasets across executor nodes. Conventional execution planners generally select broadcast join execution or shuffle-based join execution using static thresholds derived from dataset sizes or predetermined optimization heuristics established during query compilation. However, such approaches frequently fail to account for dynamic partition distributions, evolving workload conditions, heterogeneous executor capabilities, and locality relationships existing among datasets participating in the join operation. The present embodiment addresses these limitations by enabling the first reinforcement learning processor to generate join execution directives responsive to actual workload representations and observed partition characteristics associated with individual analytical queries.

Upon receipt of workload representations generated by the workload characterization processor, the first reinforcement learning processor performs a traversal of the node-edge dependency structures to identify join nodes corresponding to operations requiring integration of multiple datasets. Each identified join node is analyzed to determine the identities of participating datasets, the execution stages producing the participating datasets, lineage relationships associated with the datasets, and partition descriptors previously assigned during workload characterization procedures. The processor additionally identifies whether the join node participates within critical dependency chains extending toward multiple downstream execution stages, since join operations occupying strategically significant positions within the execution graph may warrant specialized optimization treatment.

Following identification of join nodes, the first reinforcement learning processor determines, for each join node, a degree of partition alignment between participating datasets based upon partition identifiers extracted from the workload representations. The partition identifiers represent characteristics describing how datasets are distributed across executor nodes within the Apache Spark environment. Such characteristics may include partition keys utilized during prior repartitioning operations, partition index assignments, executor locality associations, partition ownership histories, and cardinality distributions among partitions. By examining these partition identifiers, the processor evaluates whether records anticipated to participate in the join operation are already co-located within corresponding executor nodes or whether substantial redistribution activities would be required prior to execution of the join.

In one implementation, the degree of partition alignment may be determined by analyzing overlap relationships between partition identifiers associated with participating datasets. For example, where a customer transaction dataset and a customer demographic dataset have both been partitioned according to customer identifiers and distributed using equivalent partition generation rules, a high degree of partition alignment may be established because corresponding records are likely to reside within common executor nodes. Conversely, where one dataset is partitioned according to geographic regions while another dataset is partitioned according to customer identifiers, a comparatively lower degree of partition alignment may be identified due to the increased likelihood that corresponding records are distributed across distinct executor nodes.

The processor subsequently evaluates whether existing partition boundaries satisfy execution locality requirements associated with the identified join nodes. The execution locality requirements define conditions under which join operations may be executed while minimizing inter-node communication activities and preserving locality of reference with respect to intermediate datasets. Such requirements may involve determining whether a threshold proportion of corresponding partitions are already co-located within common executor nodes, whether anticipated join key distributions remain consistent across participating datasets, and whether executor assignments established for preceding execution stages permit continuation of localized processing activities during join execution.

For example, consider a financial risk assessment workload involving integration of transaction histories with account profile datasets. If both datasets are partitioned according to account identifiers and assigned to equivalent executor groups, the existing partition boundaries may satisfy execution locality requirements because account-specific records required for join processing are already positioned within the same executor nodes. Under these circumstances, execution of the join operation may proceed without initiation of large-scale shuffle activities. Conversely, if the account profile datasets are partitioned according to regional classifications while the transaction histories remain organized according to account identifiers, execution locality requirements may not be satisfied because substantial redistribution of datasets would be required to achieve partition compatibility.

Responsive to determining that existing partition boundaries satisfy execution locality requirements, the first reinforcement learning processor generates partition preservation directives. The partition preservation directives instruct downstream processing components to maintain the current partition arrangements during execution of the corresponding join operations. Preservation of partition structures enables executor nodes to directly access locally available datasets without introducing additional repartitioning activities. Such directives may further specify retention of executor assignments established during preceding execution stages to preserve continuity of localized processing behavior.

In one exemplary embodiment involving recommendation analytics, customer interaction histories and customer preference datasets may be partitioned according to customer identifiers throughout earlier execution stages. Upon determining that both datasets exhibit high partition alignment and satisfy locality requirements, the first reinforcement learning processor issues partition preservation directives instructing the execution environment to perform localized join processing using the existing partition arrangements. As a consequence, communication overhead associated with redistribution of customer records is avoided, and downstream recommendation calculations may proceed with reduced execution latency.

Alternatively, when the processor determines that existing partition boundaries fail to satisfy execution locality requirements, repartitioning directives are generated specifying partition transformation sequences to be executed before initiation of corresponding join operations. The partition transformation sequences define ordered procedures through which datasets participating in the join operation are reorganized to establish compatible partition arrangements conducive to efficient distributed processing. Rather than relying upon generic repartitioning procedures indiscriminately applied to all datasets, the present embodiment tailors partition transformation sequences according to workload-specific characteristics extracted from the workload representations.

In one implementation, the repartitioning directives may identify specific datasets requiring redistribution, define revised partition identifiers aligned with anticipated join keys, specify the sequence in which repartitioning activities should be executed relative to other computational operations, and indicate executor groups designated to receive transformed partitions. The processor may further determine whether selective repartitioning of only a subset of participating datasets is sufficient to achieve acceptable partition alignment, thereby avoiding unnecessary movement of larger datasets already exhibiting favorable locality characteristics.

As an illustrative example, consider an electronic commerce workload integrating inventory datasets partitioned according to warehouse identifiers with customer purchase histories partitioned according to customer identifiers. Direct execution of join operations involving these datasets may require extensive communication activities because records participating in the join are distributed according to incompatible partition structures. The first reinforcement learning processor therefore generates repartitioning directives specifying transformation of the inventory datasets into customer-oriented partition arrangements before initiation of the corresponding join operations. The transformation sequences may further define incremental repartitioning activities coordinated with execution stage dependencies to prevent excessive resource contention during redistribution procedures.

The selective control of broadcast join execution and shuffle-based join execution further incorporates evaluation of the implications associated with alternative join strategies under evolving workload conditions. Where partition preservation directives are feasible, the processor may prioritize execution pathways minimizing redistribution of intermediate datasets and maximizing utilization of localized resources. Where repartitioning activities are unavoidable, the processor may strategically schedule partition transformation sequences to coincide with execution intervals exhibiting favorable resource availability characteristics. Consequently, join execution strategies become adaptive rather than static, responding dynamically to the operational context represented within the workload representations.

By way of further illustration, a healthcare analytics application may involve integration of patient encounter records, laboratory test datasets, and treatment outcome repositories distributed across a large-scale Apache Spark cluster. Conventional optimization procedures may indiscriminately invoke shuffle-based join execution for each integration activity, resulting in repeated redistribution of sensitive medical datasets. Through the mechanisms described herein, the first reinforcement learning processor identifies opportunities to preserve partition arrangements established according to patient identifiers for portions of the analytical workflow exhibiting strong partition alignment, while selectively generating repartitioning directives only for datasets requiring transformation to satisfy downstream locality requirements. The resulting execution pathways substantially reduce redundant communication activities and improve continuity of localized processing operations.

Implementation of the present embodiment enables strategic control of join execution activities based upon actual partition relationships existing among datasets participating within analytical queries. By identifying join nodes, determining degrees of partition alignment, evaluating execution locality requirements, preserving partition arrangements where locality conditions are satisfied, and generating tailored partition transformation sequences where redistribution becomes necessary, the first reinforcement learning processor formulates execution directives responsive to workload-specific characteristics rather than generalized heuristics. The resulting distributed execution processes exhibit reduced cross-node communication overhead, improved preservation of data locality, enhanced compatibility between sequential execution stages, decreased synchronization delays associated with join processing activities, and improved utilization of computational resources available within the Apache Spark environment. Such capabilities contribute to more efficient execution of complex analytical workloads involving numerous interdependent join operations distributed across heterogeneous executor infrastructures.

In an embodiment, the second reinforcement learning processor is further configured to generate the executor allocation instructions by establishing execution-stage-specific resource demand profiles derived from predicted intermediate data volumes and anticipated computational intensity values, determining executor redistribution opportunities by identifying execution stages exhibiting resource underutilization simultaneously with execution stages exhibiting resource contention conditions, generating staged executor reassignment directives specifying executor migration sequences among the execution stages, and coordinating implementation of the staged executor reassignment directives according to dependency ordering information generated by the first reinforcement learning processor.

In an embodiment, the second reinforcement learning processor is configured to generate executor allocation instructions through a dynamic resource orchestration process that continuously evaluates resource consumption characteristics associated with individual execution stages and adapts executor assignments in accordance with evolving computational demands observed during distributed query execution. In contrast to conventional Apache Spark resource management approaches that allocate executors using static configurations specified prior to initiation of analytical workloads, the present embodiment enables executor resources to be reassigned among execution stages based upon predictive assessments of intermediate dataset generation behavior, anticipated computational intensity, dependency relationships, and runtime cluster conditions. Such adaptive executor allocation facilitates more efficient utilization of distributed processing resources and reduces performance degradation associated with imbalanced executor assignments.

Upon receiving strategic execution directives from the first reinforcement learning processor, the second reinforcement learning processor initiates construction of execution-stage-specific resource demand profiles corresponding to execution stages identified within the workload representations. Each resource demand profile is generated by integrating multiple execution characteristics including predicted intermediate data volumes, anticipated computational intensity values, execution stage dependency relationships, historical resource utilization patterns associated with structurally similar workloads, and runtime telemetry information obtained from executor nodes currently participating in distributed query execution. The resulting resource demand profiles provide a multidimensional representation of the anticipated resource requirements associated with each execution stage.

The predicted intermediate data volumes utilized during generation of resource demand profiles are derived through analysis of workload descriptors generated by the workload characterization processor. Such descriptors may include transformation lineage information, operator interaction relationships, aggregation characteristics, filtering selectivity indicators, join operation dependencies, and previously observed dataset expansion trends associated with comparable execution pathways. The second reinforcement learning processor evaluates the manner in which intermediate datasets evolve as execution progresses through successive computational stages. For example, filtering operations eliminating substantial proportions of incoming records may be associated with relatively modest intermediate dataset generation characteristics, whereas aggregation operations integrating information originating from multiple upstream branches may produce substantially larger intermediate outputs requiring increased executor capacity.

Anticipated computational intensity values incorporated within the resource demand profiles characterize the expected processing burden associated with execution of individual stages. Such values may be generated through examination of computational activities represented within the workload graph, including quantities of arithmetic operations, transformation complexity levels, sorting requirements, iterative processing behavior, and frequencies of interaction among execution nodes participating within common dependency chains. Execution stages involving extensive aggregation activities, complex window functions, graph traversals, or machine learning preprocessing operations may therefore receive elevated computational intensity values indicative of increased processor utilization requirements. Conversely, stages primarily involving lightweight filtering activities may exhibit comparatively reduced computational intensity characteristics.

For example, within a financial risk analysis workload integrating customer transaction histories, fraud indicators, and credit scoring information, executor nodes initially assigned to customer profile enrichment activities may become underutilized following completion of enrichment procedures. Simultaneously, downstream fraud scoring stages may experience increasing processor demand due to computationally intensive risk calculations performed across expanding intermediate datasets. The second reinforcement learning processor generates staged executor reassignment directives instructing progressive migration of selected executor resources from the enrichment stages toward the fraud scoring stages. Migration sequences may specify that executors currently completing low-priority tasks are reassigned before executors actively engaged in higher-priority activities, thereby preserving execution stability during resource redistribution.

Coordination of the staged executor reassignment directives is performed according to dependency ordering information generated by the first reinforcement learning processor. The dependency ordering information identifies relationships among execution stages and specifies the sequence in which computational activities depend upon outputs generated by preceding stages. By incorporating such dependency information into resource allocation decisions, the second reinforcement learning processor avoids reassignment activities that could adversely affect critical execution pathways or prematurely deprive upstream stages of resources necessary to satisfy downstream processing requirements.

In one representative scenario involving healthcare analytics, an execution graph may comprise patient data normalization stages followed by diagnostic inference stages and treatment recommendation stages. Dependency ordering information generated by the first reinforcement learning processor may indicate that diagnostic inference activities cannot proceed until completion of normalization operations affecting particular patient cohorts. Even if certain normalization stages appear temporarily underutilized, the second reinforcement learning processor may postpone reassignment of corresponding executor resources until dependency conditions indicate that the relevant normalization activities have sufficiently progressed. Consequently, executor redistribution decisions remain synchronized with the broader execution strategy established at the strategic planning level.

The dependency-aware coordination process further enables prioritization of executor resources toward execution stages exhibiting elevated dependency criticality characteristics. Execution stages supporting numerous downstream activities or occupying central positions within the execution graph may receive preferential access to redistributed executors because delays occurring within such stages possess increased potential to propagate throughout the analytical workflow. Conversely, execution stages exhibiting limited downstream influence may be designated as lower-priority candidates during resource contention scenarios.

In an embodiment, the second reinforcement learning processor is further configured to generate the cache distribution instructions by identifying execution stages associated with repetitive access to intermediate datasets, determining whether the intermediate datasets are referenced by multiple downstream execution stages, assigning cache persistence priorities to the intermediate datasets according to frequencies of downstream references, dynamically modifying cache reservation instructions responsive to changes in execution progress across the execution stages, and releasing previously reserved cache resources upon determining completion of all downstream execution stages dependent upon the corresponding intermediate datasets.

In an embodiment, the second reinforcement learning processor is further configured to generate cache distribution instructions through an adaptive cache orchestration mechanism designed to optimize retention and utilization of intermediate datasets generated during execution of distributed analytical queries within the Apache Spark environment. In conventional distributed query execution systems, cache management decisions are frequently governed by static persistence directives defined during application development or predetermined memory utilization thresholds established without consideration of evolving execution dependencies. Such approaches often result in inefficient occupation of cache resources by datasets exhibiting limited future utility, while simultaneously requiring repeated recomputation or repeated retrieval of intermediate datasets that are extensively utilized by multiple downstream execution stages. The present embodiment addresses these limitations by enabling the second reinforcement learning processor to dynamically identify intermediate datasets possessing elevated reuse potential and selectively maintain such datasets within cache resources according to execution-specific dependency characteristics.

Upon generation of adaptive resource allocation directives, the second reinforcement learning processor continuously monitors workload representations and execution stage relationships to identify execution stages associated with repetitive access to intermediate datasets. Such identification is performed through examination of execution lineage information, operator interaction descriptors, stage dependency chains, and telemetry information reflecting historical access patterns observed during execution of preceding analytical workloads. Intermediate datasets generated by execution stages frequently serve as inputs to multiple downstream transformations, aggregations, machine learning operations, or reporting procedures. Consequently, repeated retrieval of such datasets from persistent storage or repeated regeneration through recomputation activities may introduce substantial execution delays and unnecessary consumption of processor resources.

For instance, within a healthcare analytics workflow, an intermediate dataset comprising normalized patient records may initially receive elevated cache persistence priorities because it supports multiple downstream diagnostic inference stages. Upon completion of diagnostic analyses, however, continued reservation of cache resources for the normalized patient dataset may no longer be justified if only isolated reporting operations remain dependent upon the dataset. The second reinforcement learning processor therefore dynamically modifies cache reservation instructions by reducing the persistence priority associated with the normalized patient dataset and reallocating cache resources toward newly generated intermediate datasets supporting active treatment recommendation analyses.

The dynamic modification process may further involve adjustment of cache reservation quantities allocated to particular execution stages. Where execution telemetry indicates acceleration of downstream processing activities associated with specific datasets, cache reservations may be extended to preserve localized access efficiencies throughout completion of the corresponding analytical tasks. Alternatively, where execution delays cause prolonged inactivity among stages dependent upon certain datasets, cache allocations associated with those datasets may be reevaluated to prevent unnecessary occupation of limited memory resources.

The second reinforcement learning processor additionally determines whether previously reserved cache resources should be released following completion of all downstream execution stages dependent upon corresponding intermediate datasets. This determination is performed through continuous monitoring of dependency satisfaction conditions derived from execution stage progress indicators. Once all downstream execution stages referencing a particular intermediate dataset have successfully completed their respective processing activities, the processor identifies that no further execution benefits are likely to be derived from continued retention of the dataset within cache memory.

Responsive to such determinations, the processor generates cache release instructions specifying deallocation of previously reserved cache resources associated with the completed dependency chains. The released cache resources subsequently become available for allocation toward intermediate datasets generated by ongoing execution stages exhibiting active reuse requirements. By coordinating cache release decisions with dependency completion status, the processor avoids premature eviction of datasets still required by downstream computations while simultaneously minimizing persistence of obsolete datasets occupying valuable memory resources.

As an illustrative example, consider execution of a telecommunications analytics application involving subscriber usage profiling, anomaly detection, network optimization, and service recommendation generation. Subscriber usage profiles generated during early execution stages may initially be referenced extensively by downstream anomaly detection and optimization procedures, resulting in elevated cache persistence priorities. Following successful completion of these dependent stages, the second reinforcement learning processor determines that the subscriber usage profiles are no longer required for subsequent processing activities. Corresponding cache reservations are therefore released, permitting allocation of available memory resources toward intermediate datasets supporting active recommendation generation stages.

In another representative implementation involving financial risk assessment, aggregated market indicators generated during upstream execution stages may serve as inputs to portfolio optimization procedures, stress testing activities, and compliance reporting operations. The second reinforcement learning processor identifies these repeated references and reserves cache resources accordingly. As execution progresses and stress testing activities conclude, persistence priorities associated with the market indicators are recalculated to reflect their reduced downstream utility. Eventually, following completion of all dependent analytical stages, the reserved cache resources are relinquished and redistributed toward newly generated datasets supporting emerging execution activities.

The adaptive cache distribution procedures described herein enable the second reinforcement learning processor to transform cache management from a static resource allocation activity into a dependency-aware optimization process responsive to actual execution dynamics. Through identification of execution stages exhibiting repetitive dataset access behaviors, determination of downstream reference relationships, assignment of cache persistence priorities based upon frequencies of downstream utilization, dynamic modification of cache reservation instructions according to execution progress, and dependency-driven release of previously allocated cache resources, the processor ensures that limited cache capacities are preferentially utilized to support datasets possessing substantial analytical significance. Such adaptive cache orchestration reduces repeated recomputation of intermediate datasets, minimizes retrieval of datasets from secondary storage, improves locality of reference during downstream execution activities, enhances responsiveness to changing workload conditions, and promotes more efficient utilization of memory resources available within distributed Apache Spark infrastructures. The resulting analytical environment demonstrates improved execution continuity, reduced processing delays associated with repeated dataset access, and increased capability to sustain high-throughput execution of complex, dependency-intensive distributed queries.

In an embodiment, the third reinforcement learning processor is further configured to identify the data skew conditions associated with specific partitions by comparing task execution durations corresponding to partitions processed within a common execution stage, determining partition processing asymmetry values based upon deviations among the task execution durations, identifying skew-contributing partitions exhibiting partition processing asymmetry values exceeding dynamically updated reference ranges, generating partition redistribution directives specifying subdivision of the skew-contributing partitions into replacement partition groups, and issuing updated execution scheduling directives for assigning the replacement partition groups to different executor nodes participating in the common execution stage.

The asymmetry determination process further incorporates consideration of execution context descriptors associated with the partitions under evaluation. For instance, if a partition exhibits elevated execution duration characteristics but is simultaneously associated with substantially greater intermediate dataset generation indicators identified during workload characterization, the processor may distinguish between naturally intensive workloads and abnormal skew conditions arising from disproportionate partition assignments. Consequently, asymmetry assessments remain sensitive to the operational context of individual execution stages rather than relying exclusively upon absolute duration thresholds.

The third reinforcement learning processor continuously updates reference ranges utilized during identification of skew-contributing partitions. Unlike static skew detection approaches employing predetermined thresholds that remain unchanged regardless of evolving cluster conditions, the present embodiment maintains dynamically updated reference ranges reflecting actual execution characteristics observed during runtime. Such reference ranges may be derived from execution histories corresponding to the current analytical workload, historical telemetry records maintained within the telemetry storage unit, and progression characteristics associated with earlier execution intervals occurring within the same execution stage.

As execution proceeds, the processor identifies skew-contributing partitions exhibiting partition processing asymmetry values exceeding the dynamically updated reference ranges. Identification of such partitions indicates that the processing burdens associated with the corresponding partitions deviate sufficiently from the behaviors exhibited by peer partitions to warrant corrective redistribution interventions. Importantly, skew identification is not limited solely to detection of unusually prolonged execution durations. Rather, the processor additionally evaluates trends indicating progressive divergence in execution progress trajectories before substantial delays fully materialize. Such anticipatory detection enables earlier initiation of mitigation activities and reduces the likelihood that skew-induced bottlenecks will propagate toward downstream execution stages.

For example, within a telecommunications analytics workload processing call detail records, partitions corresponding to high-density urban subscriber populations may begin exhibiting increasingly divergent execution progress behaviors relative to partitions associated with rural subscriber populations. Even before completion delays become severe, the processor recognizes emerging asymmetry patterns exceeding updated reference ranges and designates the corresponding partitions as skew-contributing partitions requiring redistribution.

Responsive to identification of skew-contributing partitions, the third reinforcement learning processor generates partition redistribution directives specifying subdivision of the skew-contributing partitions into replacement partition groups. The subdivision process involves decomposition of oversized or disproportionately intensive partitions into multiple replacement groups exhibiting reduced processing complexity relative to the original partition. Such subdivision procedures may be performed according to partition key characteristics, data locality relationships, record cardinality distributions, or workload-specific segmentation criteria extracted from workload representations generated during earlier processing stages.

In one implementation involving financial transaction monitoring, a skew-contributing partition associated with a major institutional customer exhibiting exceptionally high transaction frequencies may be subdivided into multiple replacement partition groups organized according to transaction categories, temporal intervals, or account relationships. By decomposing the original partition into smaller processing units, the workload previously concentrated within a single executor node becomes distributable across multiple executor resources participating within the execution stage.

The generated partition redistribution directives further specify relationships between original partitions and their corresponding replacement partition groups to preserve execution correctness and maintain consistency of analytical outcomes. Metadata describing lineage relationships among subdivided partitions may therefore be retained to facilitate accurate aggregation of intermediate outputs generated during subsequent processing activities. Such lineage preservation ensures that partition redistribution operations do not compromise integrity of the underlying analytical computations.

Following generation of partition redistribution directives, the third reinforcement learning processor issues updated execution scheduling directives assigning the replacement partition groups to different executor nodes participating within the common execution stage. Assignment decisions are generated with consideration of resource availability characteristics derived from adaptive resource allocation directives established by the second reinforcement learning processor. Executor nodes exhibiting favorable processor availability, memory capacity, and locality relationships relative to the replacement partition groups may therefore receive preferential assignment treatment.

The scheduling updates additionally account for existing task obligations associated with candidate executor nodes to avoid introduction of new imbalance conditions during redistribution procedures. In one exemplary implementation involving healthcare analytics, replacement partition groups generated from skew-contributing patient datasets may be distributed among executor nodes demonstrating low processor occupancy levels and minimal task queue lengths. Consequently, the processing burden originally concentrated within a single executor becomes distributed across multiple executor nodes capable of collectively completing the workload more efficiently.

Consider a fraud detection application processing millions of financial transactions distributed across numerous customer accounts. A particular partition associated with a small subset of customers engaged in exceptionally high transaction activity may generate disproportionately extensive computational requirements during anomaly detection procedures. Conventional scheduling approaches would permit the corresponding executor node to continue processing the partition until completion, resulting in prolonged execution delays affecting subsequent fraud scoring stages. Through the mechanisms described herein, the third reinforcement learning processor identifies the partition as a skew-contributing partition based upon elevated partition processing asymmetry values, subdivides the partition into replacement groups organized according to transaction attributes, and redistributes the resulting groups among multiple executor nodes possessing available computational capacity. Fraud scoring activities dependent upon completion of the anomaly detection stage are thereby enabled to proceed without excessive delay attributable to localized workload concentration.

In an embodiment, the third reinforcement learning processor is further configured to generate the speculative execution decisions by maintaining execution progress indicators corresponding to tasks associated with a common execution stage, determining expected task completion trajectories according to execution progress indicators of previously completed peer tasks within the common execution stage, identifying candidate tasks exhibiting divergence from the expected task completion trajectories, selecting alternative executor nodes satisfying resource availability conditions derived from the adaptive resource allocation directives, and initiating duplicate execution scheduling directives for the candidate tasks while preserving execution state consistency among concurrently executing task instances.

During execution of distributed analytical workloads, the third reinforcement learning processor maintains execution progress indicators corresponding to tasks associated with a common execution stage. Such execution progress indicators provide a dynamic representation of the extent to which individual tasks have advanced toward successful completion. The indicators may include task initiation timestamps, proportions of input records processed, quantities of intermediate datasets generated, completion status of internal transformation operations, frequencies of output write activities, processor utilization trends associated with task execution intervals, memory consumption trajectories, and observed rates of progress achieved over successive telemetry collection intervals. The execution progress indicators are continuously updated through information received from telemetry acquisition procedures operating across the distributed execution environment.

The processor organizes the execution progress indicators according to execution stage membership information generated during workload characterization procedures. Consequently, tasks participating within common execution stages are evaluated collectively because such tasks generally execute equivalent computational logic over distinct data partitions. By maintaining stage-specific progress representations, the third reinforcement learning processor acquires visibility into execution patterns characterizing the broader task population associated with a given analytical operation.

Following establishment of execution progress indicators, the third reinforcement learning processor determines expected task completion trajectories according to execution progress indicators obtained from previously completed peer tasks within the common execution stage. The expected task completion trajectories represent predictive models describing how tasks participating in a particular execution stage ordinarily progress toward completion under prevailing cluster conditions. Rather than relying upon fixed duration thresholds applicable across all workloads, the processor derives these trajectories from actual execution experiences exhibited by peer tasks operating within the same analytical context.

For example, within a customer segmentation workload processing multiple data partitions containing comparable customer attributes, a subset of tasks may complete execution during initial intervals of the execution stage. The processor analyzes the progression characteristics exhibited by these completed tasks, including rates of intermediate dataset generation, patterns of processor utilization, and distributions of elapsed execution durations. Such information is subsequently utilized to establish expected completion trajectories describing the progression behaviors anticipated for remaining peer tasks associated with the stage.

The expected task completion trajectories may evolve dynamically as additional peer tasks successfully complete execution. Consequently, predictive representations of normal execution behavior remain responsive to changing cluster conditions, variations in executor availability, and workload-specific characteristics emerging during runtime. For instance, if early task completions occur under conditions of relatively low cluster utilization but later peer tasks execute amidst increasing resource contention, the processor continuously refines expected completion trajectories to reflect the changing operational environment.

Subsequently, the third reinforcement learning processor identifies candidate tasks exhibiting divergence from the expected task completion trajectories. Divergence analysis involves comparison of actual execution progress indicators associated with active tasks against the progression behaviors predicted by the expected completion trajectories. Candidate tasks may be identified when observed execution rates decline substantially relative to anticipated progression patterns, when intermediate dataset generation occurs at unexpectedly slow rates, when processor utilization behaviors indicate prolonged inactivity despite incomplete execution status, or when elapsed execution durations increasingly exceed durations exhibited by previously completed peer tasks.

Importantly, the divergence determination process incorporates contextual information associated with the execution environment to avoid inappropriate classification of naturally intensive tasks as straggler candidates. For example, if workload representations indicate that particular partitions contain elevated data volumes or inherently complex computational structures, corresponding deviations may be interpreted differently from deviations arising under otherwise equivalent execution conditions. The processor therefore evaluates divergence in conjunction with partition characteristics, execution lineage descriptors, and resource availability information to improve accuracy of candidate task identification.

In an embodiment, the telemetry storage unit is further configured to organize the historical records into workload similarity groups based upon execution graph topology characteristics, partition characteristics, shuffle requirements, aggregation operation patterns, and join operation attributes extracted from the workload representations, and wherein the policy adaptation processor is further configured to retrieve experience replay samples from different workload similarity groups according to predetermined sampling proportions that maintain representation of distinct execution conditions encountered during prior distributed query executions.

The telemetry storage unit further incorporates shuffle requirements into the workload grouping process. Shuffle requirements describe the extent to which analytical workloads depend upon redistribution of intermediate datasets among executor nodes during execution of join operations, aggregation procedures, sorting activities, or repartitioning transformations. Workloads characterized by frequent shuffle-intensive activities often require specialized optimization strategies emphasizing communication minimization and dependency-aware execution planning. Accordingly, execution histories corresponding to workloads exhibiting elevated shuffle requirements are organized into similarity groups distinct from workloads capable of preserving partition locality throughout execution.

Aggregation operation patterns extracted from workload representations additionally contribute to formation of workload similarity groups. Such patterns characterize the frequencies, nesting relationships, and dependency structures associated with aggregation activities occurring during analytical processing. For instance, workloads dominated by iterative aggregation procedures operating upon expanding intermediate datasets may exhibit optimization requirements substantially different from workloads involving isolated aggregation activities performed upon relatively static datasets. By preserving aggregation-related execution characteristics within workload similarity groups, the telemetry storage unit ensures that subsequent experience replay procedures incorporate execution histories reflective of comparable computational demands.

Join operation attributes likewise participate in workload similarity determination. These attributes may include frequencies of join occurrences, distributions of join types observed within execution plans, patterns of interaction between join operations and partition structures, and relationships between join activities and downstream execution stages. Workloads exhibiting extensive dependency upon complex join operations often generate resource utilization behaviors and scheduling requirements differing substantially from workloads involving limited integration activities. Consequently, incorporation of join operation attributes into similarity assessments further enhances the contextual relevance of experiences retrieved during policy adaptation procedures.

As historical execution records accumulate, the telemetry storage unit incrementally refines the workload similarity groups by continuously reassessing relationships among newly acquired execution histories and previously established workload categories. Execution records originating from emerging workload classes may therefore give rise to formation of additional similarity groups reflecting novel execution behaviors encountered within the distributed computing environment. Such adaptability ensures that the telemetry repository remains responsive to evolving application requirements and changing analytical workloads introduced over time.

The policy adaptation processor is configured to retrieve experience replay samples from the workload similarity groups according to predetermined sampling proportions designed to maintain representation of distinct execution conditions encountered during prior distributed query executions. Experience replay procedures enable reinforcement learning policies to revisit previously observed execution scenarios for purposes of refining decision-making behaviors without requiring repetitive exposure to identical workloads during active production operation. However, indiscriminate selection of historical experiences may bias policy adaptation processes toward frequently occurring execution conditions while neglecting less common scenarios possessing substantial operational significance.

To address this challenge, the policy adaptation processor establishes predetermined sampling proportions governing retrieval of experiences from different workload similarity groups. The sampling proportions are selected to preserve diversity among replay experiences while ensuring continued representation of execution conditions associated with structurally distinct analytical workloads. For example, workloads characterized by high shuffle requirements may contribute a specified proportion of replay samples, while workloads dominated by aggregation-intensive processing behaviors contribute a different proportion. Similarly, execution histories reflecting balanced partition distributions may coexist with experiences originating from skew-prone workloads to maintain exposure to varied resource allocation challenges.

The retrieval process further considers execution outcomes associated with individual experiences contained within the workload similarity groups. Experiences corresponding to successful mitigation of resource contention conditions, effective handling of partition skew scenarios, or efficient preservation of partition locality may receive increased sampling emphasis relative to experiences demonstrating comparatively limited optimization effectiveness. Nevertheless, the predetermined sampling proportions continue to preserve representation of diverse execution conditions rather than concentrating exclusively upon historically favorable outcomes. Such balanced replay strategies prevent reinforcement learning policies from becoming overly specialized toward narrow subsets of execution scenarios.

As an illustrative example, consider an Apache Spark deployment supporting healthcare analytics, fraud detection, recommendation generation, and telecommunications optimization workloads. The telemetry storage unit organizes execution histories originating from these workloads into similarity groups according to their respective execution graph structures, partition behaviors, shuffle dependencies, aggregation patterns, and join characteristics. During subsequent policy adaptation procedures, the policy adaptation processor retrieves experience replay samples from each workload similarity group according to predetermined sampling proportions. Consequently, reinforcement learning policies remain exposed to a broad spectrum of execution conditions ranging from shuffle-intensive fraud detection scenarios to aggregation-dominated healthcare analytics tasks. The resulting policies exhibit enhanced adaptability when confronted with newly encountered analytical workloads possessing characteristics overlapping multiple similarity groups.

In another representative implementation involving financial risk assessment environments, workloads associated with stress testing activities may generate extensive aggregation operations accompanied by evolving partition distributions, whereas regulatory reporting workloads may exhibit relatively stable execution patterns characterized by repetitive join operations. By preserving historical records within corresponding similarity groups and maintaining balanced experience replay proportions, the policy adaptation processor facilitates development of reinforcement learning policies capable of effectively addressing both workload categories without sacrificing responsiveness to either execution context.

Implementation of the present embodiment enables transformation of telemetry repositories from passive historical archives into active knowledge structures supporting context-sensitive reinforcement learning adaptation. Through organization of historical execution records into workload similarity groups derived from execution graph topology characteristics, partition characteristics, shuffle requirements, aggregation operation patterns, and join operation attributes, the telemetry storage unit preserves relationships among analytically comparable workloads encountered during prior distributed query executions. The policy adaptation processor subsequently exploits these structured repositories through retrieval of experience replay samples according to predetermined sampling proportions preserving representation of diverse execution conditions. As a result, reinforcement learning policies acquire improved generalization capabilities, enhanced responsiveness to evolving workload compositions, increased robustness against overfitting to frequently encountered scenarios, and greater effectiveness in generating optimization decisions applicable across heterogeneous Apache Spark execution environments.

In an embodiment, the reward determination processor is further configured to generate the first hierarchical reward signal by determining changes in execution graph dependency depths between successive strategic execution directives generated for substantially similar workload representations, calculating variations in quantities of shuffle-inducing execution paths occurring within corresponding node-edge dependency structures, assigning strategic reward values according to combined effects of the changes in execution graph dependency depths and the variations in quantities of shuffle-inducing execution paths, and transmitting the strategic reward values to the policy adaptation processor for updating policies associated with the first reinforcement learning processor.

In an embodiment, the reward determination processor is configured to generate the first hierarchical reward signal through a strategic evaluation mechanism that quantitatively assesses the effectiveness of execution graph decomposition decisions generated by the first reinforcement learning processor during distributed query execution within the Apache Spark environment. Unlike conventional reinforcement learning approaches in which reward signals are derived predominantly from overall query completion durations or aggregate resource utilization outcomes observed only after completion of an entire analytical workload, the present embodiment enables generation of strategic reward values directly associated with modifications introduced at the execution planning level. By explicitly evaluating changes in execution graph dependency structures and variations in shuffle propagation characteristics resulting from alternative strategic execution directives, the reward determination processor provides the first reinforcement learning processor with targeted feedback regarding the long-term implications of its decomposition decisions. Consequently, reinforcement learning updates become closely aligned with optimization objectives directed toward reducing execution dependencies and minimizing communication-intensive execution pathways.

During operation, the reward determination processor receives information describing strategic execution directives generated by the first reinforcement learning processor together with workload representations corresponding to analytical queries processed during successive execution intervals. For workloads identified as substantially similar through comparison of execution graph topology characteristics, partition characteristics, aggregation patterns, and join operation attributes, the processor establishes strategic evaluation pairs comprising current strategic execution directives and previously implemented strategic execution directives associated with analogous workload representations. Such pairwise comparisons permit isolation of the effects attributable specifically to modifications introduced by the first reinforcement learning processor while reducing the influence of unrelated variations arising from differences in workload composition.

The reward determination processor initially determines changes in execution graph dependency depths between successive strategic execution directives generated for the substantially similar workload representations. The execution graph dependency depth represents the extent to which computational operations are sequentially dependent upon completion of preceding operations before downstream execution stages may commence. Excessive dependency depths frequently reduce opportunities for parallel execution because downstream stages remain idle while awaiting completion of extensive upstream processing chains. Consequently, strategic decomposition arrangements capable of reducing dependency depths generally facilitate improved execution concurrency and more efficient utilization of distributed computational resources.

To determine dependency depth changes, the reward determination processor examines node-edge dependency structures corresponding to execution graphs generated before and after implementation of revised strategic execution directives. The processor identifies the longest dependency paths extending from root nodes representing initial computational operations toward terminal nodes corresponding to final analytical outputs. Intermediate dependency relationships occurring within branching execution structures are additionally evaluated to determine whether strategic modifications introduced opportunities for decomposition of previously sequential operations into independently executable graph segments. The resulting dependency depth measurements are subsequently compared to identify whether execution graph restructuring activities generated by the first reinforcement learning processor have shortened, preserved, or increased dependency chains within the analytical workload.

For example, consider a customer analytics workload involving data ingestion operations followed by customer profile enrichment, behavioral aggregation, recommendation generation, and campaign optimization stages. An initial strategic execution directive may organize these operations into a deeply sequential execution graph requiring completion of each stage before initiation of subsequent processing activities. Following policy adaptation, the first reinforcement learning processor may generate an alternative decomposition arrangement separating independent recommendation generation branches from campaign optimization procedures capable of executing concurrently after completion of behavioral aggregation activities. The reward determination processor identifies the resulting reduction in dependency depths and interprets the modification as indicative of improved execution planning effectiveness.

The reward determination processor further calculates variations in quantities of shuffle-inducing execution paths occurring within corresponding node-edge dependency structures. Shuffle-inducing execution paths represent sequences of computational activities requiring redistribution of intermediate datasets among executor nodes through communication-intensive operations. Such operations frequently involve substantial network transmission overhead, increased disk input-output activity, synchronization delays, and elevated resource consumption. Consequently, reduction of shuffle propagation pathways constitutes an important objective for strategic execution planning activities performed by the first reinforcement learning processor.

The calculation of shuffle variations involves identification of execution paths traversing nodes associated with repartitioning transformations, shuffle-based join operations, global sorting activities, grouping operations requiring redistribution of intermediate datasets, and aggregation procedures involving cross-node communication. The reward determination processor determines the quantity of distinct execution paths affected by such shuffle-inducing nodes and evaluates whether modifications introduced through revised strategic execution directives have altered the prevalence or propagation characteristics of communication-intensive activities throughout the execution graph.

In one illustrative implementation involving fraud detection analytics, an initial execution plan may require repeated redistribution of transaction datasets during multiple enrichment and anomaly detection stages. Subsequent strategic execution directives generated by the first reinforcement learning processor may reorganize execution boundaries to preserve partition locality across related computational stages, thereby reducing the quantity of execution paths traversing shuffle-inducing operations. The reward determination processor identifies the resulting decrease in shuffle propagation pathways and interprets such changes as evidence of improved strategic planning behavior.

The reward determination processor subsequently assigns strategic reward values according to the combined effects of the changes in execution graph dependency depths and the variations in quantities of shuffle-inducing execution paths. Rather than evaluating these factors independently, the processor generates integrated reward assessments reflecting the interaction between execution concurrency opportunities and communication overhead characteristics. Strategic execution directives yielding reductions in dependency depths while simultaneously reducing shuffle propagation pathways receive elevated strategic reward values because such directives contribute toward more efficient distributed execution behavior.

Conversely, strategic directives reducing dependency depths at the expense of introducing extensive additional shuffle pathways may receive comparatively moderated reward values reflecting the trade-offs associated with increased communication requirements. Similarly, decomposition arrangements preserving shuffle locality while substantially increasing dependency depths may receive limited reinforcement due to their potential to constrain parallel execution opportunities. Through evaluation of the combined effects of these factors, the reward determination processor encourages the emergence of strategic policies balancing decomposition efficiency with communication minimization objectives.

For example, consider a healthcare analytics application involving patient normalization procedures, diagnostic inference stages, treatment recommendation activities, and outcome reporting operations. One strategic execution directive may substantially reduce dependency depths by aggressively decomposing the execution graph into numerous independently executable segments. However, if such decomposition simultaneously necessitates repeated redistribution of patient datasets across executor nodes, the resulting increase in shuffle propagation pathways may offset benefits associated with enhanced parallelism. The reward determination processor therefore generates strategic reward values reflecting both aspects of execution behavior rather than emphasizing only a single optimization objective.

The generated strategic reward values are transmitted to the policy adaptation processor for updating policies associated with the first reinforcement learning processor. During policy adaptation procedures, the strategic reward values serve as evaluative feedback indicating the effectiveness of decomposition decisions previously implemented during execution of substantially similar workloads. Strategic execution directives associated with favorable reward outcomes reinforce the selection tendencies of the first reinforcement learning processor, whereas directives producing unfavorable reward outcomes diminish the likelihood of recurrence during future execution planning activities.

Importantly, the reward transmission process preserves associations between strategic reward values and the workload representations from which such rewards originated. Consequently, the policy adaptation processor may refine strategic policies in a workload-sensitive manner rather than applying identical reinforcement adjustments across unrelated analytical contexts. Workloads exhibiting similar execution graph characteristics therefore benefit from accumulated strategic experiences acquired during previous optimization cycles.

As an illustrative example, consider a telecommunications analytics environment executing subscriber profiling, anomaly detection, capacity planning, and service optimization activities. Historical execution records may reveal that decomposition strategies reducing dependency depths among subscriber profiling stages while preserving locality relationships during anomaly detection procedures consistently yield favorable strategic reward values. The policy adaptation processor utilizes these rewards to strengthen policy preferences supporting analogous decomposition arrangements during subsequent telecommunications workloads exhibiting similar execution structures.

In another representative implementation involving financial risk assessment applications, stress testing activities may require extensive interaction among simulation stages, portfolio aggregation procedures, and compliance evaluation operations. Strategic execution directives minimizing shuffle propagation during portfolio aggregation while concurrently reducing dependency relationships among simulation branches may receive elevated reward values from the reward determination processor. Over successive policy adaptation cycles, the first reinforcement learning processor increasingly prioritizes decomposition arrangements exhibiting these characteristics when confronted with comparable analytical workloads.

The strategic reward generation procedures described herein enable reinforcement learning adaptation processes to incorporate direct feedback regarding the consequences of execution planning decisions occurring at the highest level of the hierarchical architecture. Through determination of changes in execution graph dependency depths, calculation of variations in shuffle-inducing execution pathways, assignment of integrated strategic reward values reflecting combined execution effects, and transmission of the resulting reward signals to the policy adaptation processor, the reward determination processor establishes a mechanism through which strategic optimization behaviors evolve according to empirically observed execution outcomes. The resulting reinforcement learning policies demonstrate improved capability to generate execution graph decomposition arrangements that promote balanced reductions in dependency complexity and communication overhead, enhance opportunities for concurrent processing activities, reduce propagation of shuffle-related bottlenecks, and support more efficient execution of complex distributed analytical workloads operating within Apache Spark environments.

In an embodiment, the reward determination processor is further configured to generate the second hierarchical reward signal by identifying processor utilization disparities among executor nodes participating in common execution stages, determining memory reservation inefficiencies according to relationships between allocated memory capacities and observed memory occupancy values, identifying cache reservation mismatches according to frequencies of access to reserved datasets, generating resource allocation effectiveness indicators from the processor utilization disparities, the memory reservation inefficiencies, and the cache reservation mismatches, and transmitting the resource allocation effectiveness indicators to the policy adaptation processor for updating policies associated with the second reinforcement learning processor.

In an embodiment, the reward determination processor is configured to generate the second hierarchical reward signal through a multidimensional evaluation procedure directed toward assessing the effectiveness of adaptive resource allocation decisions generated by the second reinforcement learning processor during execution of distributed analytical workloads within the Apache Spark environment. Unlike conventional reward generation mechanisms that primarily evaluate overall query execution duration or aggregate cluster utilization after completion of entire analytical processes, the present embodiment provides a resource-specific feedback mechanism that continuously examines the consequences of executor allocation decisions at the operational level where processor assignments, memory reservations, and cache distributions directly influence execution efficiency. By generating reward signals derived from actual resource utilization characteristics observed during execution of common stages, the reward determination processor enables the second reinforcement learning processor to progressively refine its allocation strategies in accordance with the evolving demands of heterogeneous workloads executed across distributed computing infrastructures.

During execution of analytical queries, the reward determination processor receives telemetry information acquired from executor nodes participating within common execution stages together with adaptive resource allocation directives previously generated by the second reinforcement learning processor. The processor establishes resource evaluation windows corresponding to execution intervals during which groups of executor nodes collectively process tasks associated with a particular execution stage. By restricting comparisons to executor nodes participating in common stages, the reward determination processor ensures that the observed utilization characteristics reflect equivalent computational objectives and therefore permit meaningful assessment of resource allocation effectiveness.

The reward determination processor initially identifies processor utilization disparities among executor nodes participating in common execution stages. Processor utilization disparities arise when computational workloads assigned to different executor nodes result in substantially different processor occupancy characteristics despite participation within identical execution stages. Such disparities frequently indicate inefficiencies in executor allocation decisions because certain executor nodes may remain underutilized while others experience sustained resource contention conditions leading to increased task waiting durations and elongated execution times.

To identify processor utilization disparities, the reward determination processor examines processor utilization measurements collected from each executor node during the resource evaluation windows. The measurements are analyzed collectively to determine the extent to which processing burdens remain balanced across participating executor nodes. Executor nodes exhibiting prolonged periods of elevated processor occupancy combined with increasing task queue lengths are distinguished from executor nodes demonstrating comparatively low utilization levels and extended idle intervals. The resulting utilization profiles provide insight into whether the adaptive resource allocation directives generated by the second reinforcement learning processor successfully distributed computational demands throughout the available execution infrastructure.

For example, within a customer recommendation workload executed across multiple executor nodes, one subset of executor nodes may exhibit processor utilization values approaching full operational capacity while another subset remains substantially underutilized. Such disparities suggest that the resource allocation directives failed to distribute recommendation processing activities evenly among available executors. The reward determination processor therefore interprets these observations as indicative of reduced resource allocation effectiveness and incorporates the identified disparities into subsequent reward generation procedures.

The reward determination processor further determines memory reservation inefficiencies according to relationships between allocated memory capacities and observed memory occupancy values corresponding to executor nodes participating in common execution stages. Memory reservations generated by the second reinforcement learning processor are intended to provide sufficient resources for efficient execution of analytical tasks while minimizing unnecessary reservation of memory capacities that could otherwise support additional computational activities. However, inaccurate memory reservations may result in either excessive memory allocation leading to inefficient resource utilization or insufficient memory allocation contributing to repeated page faults, increased storage access activities, and degradation of execution performance.

Determination of memory reservation inefficiencies therefore involves comparison of the memory capacities allocated to executor nodes against actual memory occupancy behaviors observed during execution. Where allocated memory capacities substantially exceed the memory resources actively utilized during execution, the reward determination processor identifies inefficiencies associated with over-reservation of memory resources. Conversely, where observed memory occupancy consistently approaches or exceeds allocated capacities and is accompanied by elevated memory page fault occurrences or increased disk input-output waiting durations, the processor identifies inefficiencies associated with under-reservation of memory resources.

As an illustrative example, consider a healthcare analytics application involving diagnostic inference procedures executed using distributed patient datasets. The second reinforcement learning processor may initially reserve substantial memory capacities for executor nodes participating in inference stages due to anticipated intermediate dataset generation requirements. If telemetry observations subsequently reveal that actual memory occupancy remains significantly below the reserved capacities throughout execution, the reward determination processor recognizes that the allocated memory resources exceeded operational requirements. Alternatively, if memory occupancy consistently reaches allocated limits and execution stages exhibit increasing storage access delays attributable to insufficient memory availability, the processor identifies under-reservation conditions requiring modification of future allocation strategies.

The reward determination processor additionally identifies cache reservation mismatches according to frequencies of access to reserved datasets. Cache reservation directives generated by the second reinforcement learning processor aim to preserve intermediate datasets anticipated to support repetitive downstream processing activities. Nevertheless, evolving workload conditions may alter dataset access patterns such that certain reserved datasets receive substantially fewer accesses than originally predicted, while other frequently utilized datasets remain insufficiently represented within available cache resources. Such mismatches diminish the effectiveness of cache allocation decisions and may contribute to unnecessary recomputation activities or increased retrieval operations from persistent storage systems.

To identify cache reservation mismatches, the reward determination processor evaluates cache access telemetry collected during execution and compares observed dataset access frequencies against the cache persistence priorities originally assigned by the second reinforcement learning processor. Reserved datasets exhibiting minimal downstream utilization despite continued occupation of cache resources are identified as over-prioritized datasets. Conversely, datasets demonstrating repeated retrieval activities despite limited cache representation are recognized as under-prioritized datasets. The resulting cache utilization profiles provide feedback regarding the accuracy of predictive cache allocation decisions implemented during earlier execution intervals.

For instance, within a telecommunications analytics workload, intermediate subscriber behavior datasets may initially receive elevated cache persistence priorities because they are expected to support multiple downstream optimization procedures. If execution telemetry subsequently reveals that only a subset of the anticipated downstream stages ultimately accesses the subscriber datasets, the reward determination processor identifies the corresponding cache reservations as mismatched relative to actual utilization patterns. Alternatively, network anomaly datasets exhibiting unexpectedly high frequencies of downstream access may reveal deficiencies in existing cache reservation directives requiring reinforcement learning adjustments.

Following identification of processor utilization disparities, memory reservation inefficiencies, and cache reservation mismatches, the reward determination processor generates resource allocation effectiveness indicators reflecting the combined influence of these observations upon overall execution efficiency. The resource allocation effectiveness indicators provide a multidimensional assessment of how effectively the adaptive resource allocation directives generated by the second reinforcement learning processor translated into balanced utilization of available computational resources.

Rather than emphasizing isolated resource categories independently, the processor evaluates interactions among processor utilization behaviors, memory reservation outcomes, and cache utilization characteristics. For example, processor utilization disparities occurring concurrently with pronounced memory reservation inefficiencies may indicate that certain executor nodes are processing disproportionately intensive workloads without adequate memory support, thereby exacerbating performance degradation. Similarly, cache reservation mismatches accompanied by elevated processor utilization levels may suggest that repeated recomputation activities arising from ineffective caching strategies contribute to unnecessary processor consumption.

In one representative financial risk assessment scenario, stress testing activities may demonstrate balanced processor utilization characteristics but exhibit extensive memory over-reservation conditions accompanied by underutilization of reserved cache resources. Although processor assignments may appear effective in isolation, the combined evaluation performed by the reward determination processor reveals opportunities for improved resource efficiency through refinement of memory and cache allocation policies. Conversely, a fraud detection workload may exhibit pronounced processor utilization disparities despite effective memory reservations, indicating that executor redistribution strategies require greater emphasis during future policy adaptation cycles.

The generated resource allocation effectiveness indicators are subsequently transmitted to the policy adaptation processor for updating policies associated with the second reinforcement learning processor. The policy adaptation processor utilizes the effectiveness indicators as evaluative feedback describing the operational consequences of previous resource allocation decisions. Allocation strategies associated with favorable effectiveness indicators reinforce policy tendencies supporting balanced processor utilization, accurate memory reservations, and efficient cache distributions. Conversely, resource allocation directives leading to substantial disparities, reservation inefficiencies, or cache mismatches contribute toward adjustment of policy parameters to reduce recurrence of similar allocation behaviors during subsequent analytical workloads.

Importantly, the resource allocation effectiveness indicators remain linked to the workload contexts from which they originated. Consequently, policy adaptation activities may preserve distinctions among allocation strategies effective within different classes of analytical workloads. Resource allocation decisions beneficial for shuffle-intensive telecommunications analyses may therefore evolve independently from decisions supporting aggregation-dominated healthcare workloads or partition-sensitive fraud detection scenarios. Such contextual reinforcement facilitates development of adaptive resource management policies capable of responding appropriately to diverse execution environments encountered within large-scale Apache Spark deployments.

By continuously identifying processor utilization disparities, determining memory reservation inefficiencies, evaluating cache reservation mismatches, generating integrated resource allocation effectiveness indicators, and transmitting these indicators to the policy adaptation processor, the reward determination processor establishes a resource-aware reinforcement mechanism directly aligned with the operational objectives of the second reinforcement learning processor. The resulting reinforcement learning framework exhibits improved capability to balance computational demands among executor nodes, align memory reservations with actual workload requirements, optimize utilization of cache resources supporting downstream analytical stages, and refine adaptive resource allocation strategies according to empirically observed execution behaviors. Consequently, distributed query execution processes become increasingly efficient, resilient to evolving workload conditions, and capable of sustaining improved utilization of heterogeneous computational resources within Apache Spark environments.

In an embodiment, the reward determination processor is further configured to generate the third hierarchical reward signal by determining task waiting durations associated with tasks scheduled during common execution intervals, identifying execution stages exhibiting repeated straggler task occurrences, calculating workload distribution non-uniformity values according to disparities in task completion frequencies among executor nodes, generating scheduling effectiveness indicators from the task waiting durations, the repeated straggler task occurrences, and the workload distribution non-uniformity values, and transmitting the scheduling effectiveness indicators to the policy adaptation processor for updating policies associated with the third reinforcement learning processor.

In an embodiment, the reward determination processor is configured to generate the third hierarchical reward signal through a scheduling-oriented evaluation mechanism specifically designed to assess the effectiveness of execution scheduling decisions generated by the third reinforcement learning processor during runtime operation of distributed analytical workloads within the Apache Spark environment. Unlike conventional reward generation approaches that evaluate scheduling outcomes solely according to overall query completion durations, the present embodiment provides a fine-grained assessment of scheduling behavior by examining task waiting characteristics, recurrence of straggler task phenomena, and uniformity of workload distribution across executor nodes participating within common execution stages. Such an approach enables the reinforcement learning architecture to directly associate reward feedback with scheduling-specific operational outcomes, thereby facilitating progressive refinement of task placement strategies, speculative execution behaviors, workload migration decisions, and executor assignment mechanisms employed during adaptive distributed query execution.

During execution of analytical queries, the reward determination processor continuously receives scheduling telemetry information corresponding to tasks distributed across the plurality of executor nodes. The telemetry information includes task submission timestamps, task queue entry timestamps, task initiation timestamps, task completion timestamps, executor assignment records, speculative execution histories, workload migration events, and execution stage identifiers associated with individual tasks. The reward determination processor organizes the received telemetry information according to common execution intervals corresponding to distinct execution stages generated during distributed query processing. By restricting evaluations to tasks operating within equivalent execution contexts, the processor ensures that the resulting reward signals accurately reflect the effectiveness of scheduling decisions implemented under comparable workload conditions.

The reward determination processor initially determines task waiting durations associated with tasks scheduled during common execution intervals. Task waiting durations represent the elapsed periods between the point at which tasks become eligible for execution and the point at which corresponding executor nodes initiate actual processing activities. Excessive task waiting durations frequently indicate inefficiencies in task placement strategies, inadequate utilization of available executor capacities, or suboptimal prioritization of execution activities occurring within scheduling queues. Consequently, evaluation of waiting durations provides valuable insight into the responsiveness of scheduling decisions generated by the third reinforcement learning processor.

Determination of task waiting durations involves comparison of task queue entry timestamps with corresponding task initiation timestamps for tasks belonging to a common execution stage. The reward determination processor subsequently aggregates waiting duration observations to characterize the overall scheduling responsiveness exhibited during execution of the stage. Tasks experiencing minimal waiting intervals are interpreted as evidence that scheduling directives effectively utilized available executor resources. Conversely, tasks exhibiting prolonged waiting periods suggest the presence of bottlenecks attributable to inefficient workload placement, insufficient redistribution of execution responsibilities, or delayed activation of speculative execution procedures.

For example, within a recommendation analytics workload involving generation of personalized content suggestions across numerous customer partitions, tasks responsible for processing customer segments may become eligible for execution simultaneously. If the majority of tasks experience only brief waiting durations prior to assignment to executor nodes, the scheduling strategy may be regarded as effective. However, if a subset of tasks remains queued for extended periods despite availability of underutilized executor resources elsewhere within the cluster, the reward determination processor recognizes deficiencies in scheduling performance and incorporates corresponding observations into subsequent reward calculations.

The reward determination processor further identifies execution stages exhibiting repeated straggler task occurrences. Straggler tasks are execution tasks that progress substantially slower than peer tasks participating within the same execution stage, thereby delaying initiation of dependent downstream processing activities. Although isolated straggler events may occasionally arise due to transient environmental fluctuations, repeated emergence of straggler tasks within particular execution stages frequently reflects systematic inadequacies in scheduling policies governing task placement, workload balancing, or speculative execution activation. The reward determination processor therefore evaluates not merely the existence of isolated straggler incidents but rather the recurrence patterns associated with such phenomena across execution intervals.

Identification of repeated straggler task occurrences is accomplished by analyzing execution duration profiles corresponding to tasks participating within common execution stages. Tasks exhibiting completion durations substantially exceeding those observed among peer tasks are classified as straggler instances. The processor subsequently determines whether particular execution stages demonstrate recurring tendencies toward straggler formation across successive execution intervals or repeated workload invocations. Stages repeatedly associated with delayed task completions are interpreted as indicative of scheduling strategies requiring refinement.

For instance, within a telecommunications analytics environment processing subscriber behavior records, anomaly detection tasks associated with specific partitions may repeatedly emerge as stragglers due to inadequate consideration of partition characteristics during scheduling activities. If successive execution intervals consistently reveal delayed completion behaviors among such tasks, the reward determination processor identifies the corresponding execution stages as exhibiting repeated straggler occurrences. These observations contribute toward generation of reward signals discouraging continuation of scheduling policies responsible for persistent straggler formation.

The reward determination processor additionally calculates workload distribution non-uniformity values according to disparities in task completion frequencies among executor nodes participating within common execution stages. Ideally, executor nodes assigned comparable execution responsibilities should contribute relatively balanced proportions of completed tasks throughout the execution interval. Significant disparities in task completion frequencies may indicate uneven distribution of workload assignments, excessive concentration of computational burdens upon specific executor groups, or insufficient utilization of available processing capacities residing elsewhere within the cluster infrastructure.

Calculation of workload distribution non-uniformity values involves monitoring the quantities of tasks successfully completed by individual executor nodes during the common execution intervals. The processor subsequently evaluates the degree to which completion frequencies remain balanced across participating executor populations. Executor nodes consistently completing disproportionately high quantities of tasks while neighboring nodes exhibit reduced activity levels contribute toward elevated non-uniformity values. Conversely, balanced task completion patterns distributed throughout the executor population yield comparatively lower non-uniformity values indicative of effective workload allocation.

As an illustrative example, consider a healthcare analytics application involving execution of patient outcome prediction tasks distributed across numerous executor nodes. If telemetry observations reveal that a limited subset of executor nodes consistently processes the majority of prediction tasks while other executor nodes remain partially idle, the reward determination processor determines that workload distribution non-uniformity exists within the scheduling directives governing the execution stage. Such non-uniformity suggests opportunities for improvement through refinement of task placement strategies and executor utilization policies.

The reward determination processor subsequently generates scheduling effectiveness indicators from the task waiting durations, the repeated straggler task occurrences, and the workload distribution non-uniformity values. Rather than evaluating these scheduling characteristics independently, the processor synthesizes the observations into integrated indicators reflecting the overall effectiveness of runtime scheduling behaviors exhibited by the third reinforcement learning processor. Scheduling strategies producing brief task waiting durations, minimal recurrence of straggler phenomena, and balanced workload distributions among executor nodes receive favorable effectiveness assessments. Conversely, strategies associated with prolonged waiting intervals, repeated straggler formation, and pronounced workload imbalances generate less favorable effectiveness indicators.

Importantly, the integrated evaluation approach accommodates situations in which isolated scheduling metrics might otherwise provide misleading interpretations if considered independently. For example, scheduling policies aggressively prioritizing immediate task initiation may minimize waiting durations but inadvertently increase recurrence of straggler tasks through inadequate consideration of executor suitability. Similarly, uniform workload distributions achieved without regard to executor locality characteristics may reduce completion disparities while increasing communication overhead and prolonging downstream execution activities. Through simultaneous consideration of multiple scheduling dimensions, the reward determination processor facilitates balanced reinforcement learning adaptations aligned with broader execution objectives.

For instance, within a financial fraud detection workload involving anomaly scoring across millions of transactions, a scheduling strategy may successfully reduce task waiting durations by rapidly assigning tasks to any available executor nodes. However, if the resulting assignments repeatedly produce straggler behaviors because executor suitability characteristics are disregarded, the integrated scheduling effectiveness indicators generated by the reward determination processor appropriately moderate the resulting reward outcomes. Conversely, scheduling directives that achieve both reduced waiting durations and diminished straggler frequencies while preserving balanced executor participation receive increasingly favorable evaluations.

The generated scheduling effectiveness indicators are transmitted to the policy adaptation processor for updating policies associated with the third reinforcement learning processor. The policy adaptation processor utilizes these indicators to refine scheduling strategies governing task placement decisions, workload migration procedures, speculative execution initiation behaviors, and executor assignment priorities. Scheduling decisions historically associated with favorable effectiveness indicators become increasingly reinforced during future policy updates, whereas decisions contributing toward elevated waiting durations, repeated straggler formation, or workload imbalances undergo progressive modification.

The transmission process preserves associations between scheduling effectiveness indicators and the execution contexts from which they originated. Consequently, scheduling policies may evolve differently across distinct categories of analytical workloads exhibiting diverse execution characteristics. Workloads characterized by extensive shuffle dependencies may therefore develop scheduling behaviors emphasizing locality preservation and proactive speculative execution activation, while aggregation-dominated workloads may prioritize balanced executor participation and mitigation of emerging straggler conditions associated with computational intensity disparities.

As an illustrative example, within a recommendation generation environment supporting electronic commerce applications, historical execution records may reveal that proactive redistribution of customer partitions combined with early initiation of speculative execution consistently reduces straggler occurrences and promotes balanced workload completion frequencies among executor nodes. The scheduling effectiveness indicators generated under such conditions reinforce corresponding scheduling policies within the third reinforcement learning processor. In contrast, healthcare analytics workloads emphasizing preservation of patient data locality may evolve alternative scheduling preferences reflecting the unique operational characteristics of those environments.

Through determination of task waiting durations, identification of repeated straggler task occurrences, calculation of workload distribution non-uniformity values, generation of integrated scheduling effectiveness indicators, and transmission of the resulting reward signals to the policy adaptation processor, the reward determination processor establishes a comprehensive scheduling feedback mechanism supporting continuous refinement of runtime execution control policies. The resulting reinforcement learning architecture exhibits improved capability to minimize delays associated with task queuing activities, reduce propagation of straggler-induced execution bottlenecks, promote balanced utilization of executor resources, enhance responsiveness of speculative execution strategies, and sustain efficient execution of heterogeneous analytical workloads within distributed Apache Spark infrastructures. The cumulative effect of these adaptive scheduling refinements is reflected in increasingly stable execution behaviors, improved predictability of stage completion characteristics, and enhanced efficiency of large-scale distributed query processing environments.

In an embodiment, the policy synchronization processor is further configured to perform hierarchical constraint propagation by translating strategic execution objectives received from the first reinforcement learning processor into resource dependency conditions governing operation of the second reinforcement learning processor, generating scheduling feasibility conditions according to adaptive resource allocation objectives received from the second reinforcement learning processor, transmitting the scheduling feasibility conditions to the third reinforcement learning processor prior to generation of execution scheduling directives, receiving execution feedback corresponding to implemented execution scheduling directives, and modifying subsequently transmitted resource dependency conditions according to the received execution feedback.

In an embodiment, the policy synchronization processor is configured to perform hierarchical constraint propagation to establish coordinated decision-making among the first reinforcement learning processor, the second reinforcement learning processor, and the third reinforcement learning processor, thereby enabling the distributed query execution system to function as an integrated optimization architecture rather than a collection of independently operating learning entities. In conventional multi-layer optimization systems, strategic planning decisions, resource allocation activities, and runtime scheduling actions are often generated in isolation, resulting in conflicting objectives and suboptimal execution outcomes. For example, execution plans emphasizing aggressive partition preservation may inadvertently restrict resource redistribution opportunities, while scheduling directives seeking rapid task execution may disregard strategic execution dependencies established during higher-level planning stages. The present embodiment addresses such deficiencies by introducing a synchronization mechanism that continuously propagates constraints downward through the hierarchical reinforcement learning architecture while simultaneously propagating execution feedback upward to refine subsequent optimization decisions.

During operation, the policy synchronization processor receives strategic execution objectives generated by the first reinforcement learning processor following evaluation of workload representations and execution graph structures associated with incoming analytical queries. The strategic execution objectives define high-level execution intentions describing how distributed query processing should proceed across the execution graph. Such objectives may include preservation of partition affinity relationships across dependent execution stages, minimization of shuffle propagation pathways, prioritization of execution stages exhibiting elevated dependency criticality characteristics, selective decomposition of execution graphs into independently executable segments, and maintenance of locality relationships among intermediate datasets supporting multiple downstream computational activities.

Rather than directly transmitting the strategic execution objectives to lower reinforcement learning layers in their original form, the policy synchronization processor translates the strategic execution objectives into resource dependency conditions governing operation of the second reinforcement learning processor. This translation process establishes operational constraints that transform abstract strategic intentions into resource-oriented directives capable of influencing executor allocation decisions, memory reservation policies, cache persistence strategies, and storage utilization behaviors. The translation mechanism therefore serves as an interface between the planning-oriented perspective of the first reinforcement learning processor and the resource-oriented perspective of the second reinforcement learning processor.

For example, if the first reinforcement learning processor generates strategic execution objectives emphasizing preservation of partition locality across a sequence of aggregation and join operations, the policy synchronization processor translates such objectives into resource dependency conditions specifying that executor allocations should preferentially maintain continuity of partition ownership among designated executor groups. The resulting resource dependency conditions may further indicate that memory reservations associated with executor nodes responsible for maintaining locality relationships should not be prematurely released while downstream stages remain dependent upon corresponding intermediate datasets. Consequently, resource allocation decisions generated by the second reinforcement learning processor remain aligned with the strategic objective of preserving localized processing activities.

Similarly, where the first reinforcement learning processor identifies execution stages exhibiting elevated dependency criticality values due to extensive downstream propagation effects, the policy synchronization processor translates these strategic priorities into resource dependency conditions requiring preferential allocation of executor resources toward the critical execution stages. Such conditions may constrain redistribution of executors away from strategically significant stages until completion thresholds associated with dependent downstream operations have been satisfied. As a result, resource allocation behaviors become informed by the broader execution objectives established during strategic planning.

Following generation of the resource dependency conditions, the second reinforcement learning processor utilizes the translated constraints while formulating adaptive resource allocation objectives. These objectives describe how executor assignments, processor allocations, memory reservations, cache distributions, and storage utilization strategies should evolve during execution of distributed analytical workloads. The policy synchronization processor subsequently receives the adaptive resource allocation objectives and evaluates whether the proposed allocations provide an adequate operational foundation for generation of feasible runtime scheduling directives.

Responsive to receipt of the adaptive resource allocation objectives, the policy synchronization processor generates scheduling feasibility conditions according to the resource allocation characteristics specified by the second reinforcement learning processor. The scheduling feasibility conditions define operational boundaries within which the third reinforcement learning processor may formulate execution scheduling directives. Such conditions ensure that scheduling decisions remain compatible with the executor capacities, memory reservations, cache allocations, and locality relationships established through preceding resource allocation activities.

In one implementation, scheduling feasibility conditions may specify groups of executor nodes eligible to receive tasks associated with particular execution stages, identify limitations governing migration of workloads among executor populations, define conditions under which speculative execution activities may be initiated, and establish constraints intended to preserve locality relationships among intermediate datasets. For example, if adaptive resource allocation objectives reserve cache resources for datasets supporting multiple downstream analytical stages, the scheduling feasibility conditions may direct the third reinforcement learning processor to preferentially assign dependent tasks to executor nodes possessing access to the corresponding cache reservations.

As an illustrative example, consider a fraud detection application involving transaction enrichment stages followed by anomaly scoring procedures and downstream risk aggregation activities. Strategic execution objectives generated by the first reinforcement learning processor may emphasize preservation of account-based partition locality throughout anomaly scoring operations. The policy synchronization processor translates these objectives into resource dependency conditions requiring the second reinforcement learning processor to maintain executor assignments aligned with account-specific partition structures. The resulting adaptive resource allocation objectives reserve executor capacities and memory resources within designated executor groups. The policy synchronization processor subsequently generates scheduling feasibility conditions instructing the third reinforcement learning processor to assign anomaly scoring tasks preferentially to executor nodes satisfying the established locality constraints. Consequently, runtime scheduling activities remain synchronized with both strategic planning decisions and resource allocation policies.

The generated scheduling feasibility conditions are transmitted to the third reinforcement learning processor prior to generation of execution scheduling directives. The third reinforcement learning processor therefore performs task placement activities, workload migration procedures, speculative execution decisions, and task reprioritization operations within the operational boundaries established through hierarchical synchronization. This constraint-aware scheduling approach prevents the emergence of scheduling directives that would undermine previously established strategic objectives or invalidate resource allocation assumptions.

For example, absent synchronization mechanisms, the third reinforcement learning processor might initiate speculative execution activities by assigning duplicate task instances to executor nodes lacking access to critical intermediate datasets preserved through cache reservations established by the second reinforcement learning processor. Such decisions could introduce unnecessary communication overhead and diminish the effectiveness of preceding optimization efforts. Through transmission of scheduling feasibility conditions, the present embodiment avoids these inconsistencies by ensuring that scheduling decisions remain compatible with existing resource configurations.

Subsequent to implementation of execution scheduling directives, the policy synchronization processor receives execution feedback corresponding to the actual outcomes of the scheduling activities performed by the third reinforcement learning processor. The execution feedback comprises telemetry information describing task completion characteristics, workload migration effectiveness, speculative execution outcomes, executor utilization behaviors, task waiting durations, straggler mitigation results, locality preservation effectiveness, and resource consumption patterns observed during execution. Such feedback provides insight into the extent to which synchronized decisions generated throughout the hierarchical architecture successfully translated into favorable operational outcomes.

The policy synchronization processor analyzes the execution feedback to identify discrepancies between anticipated execution behaviors and observed runtime characteristics. For instance, if scheduling directives generated under specific resource dependency conditions repeatedly result in elevated task waiting durations or persistent straggler phenomena, the processor may infer that the existing constraints imposed upon the second reinforcement learning processor require refinement. Similarly, if locality preservation objectives consistently produce favorable execution outcomes without introducing resource contention, the synchronization processor may strengthen corresponding dependency conditions during future optimization cycles.

Based upon the received execution feedback, the policy synchronization processor modifies subsequently transmitted resource dependency conditions governing operation of the second reinforcement learning processor. Such modifications represent a feedback-driven adaptation process through which the hierarchical reinforcement learning architecture continuously improves coordination among its constituent decision layers. Resource dependency conditions associated with unfavorable scheduling outcomes may be relaxed to provide greater flexibility during future resource allocation activities. Conversely, dependency conditions contributing to balanced workload distributions, reduced communication overhead, or improved speculative execution effectiveness may be reinforced to preserve successful optimization patterns.

In one representative healthcare analytics scenario, strategic objectives emphasizing preservation of patient-based partition locality may initially be translated into highly restrictive resource dependency conditions limiting executor redistribution opportunities. Execution feedback subsequently reveals that the resulting scheduling directives generate prolonged task waiting durations during computationally intensive treatment recommendation stages. The policy synchronization processor responds by modifying future resource dependency conditions to permit controlled redistribution of selected executor resources while preserving critical locality relationships for only the most dependency-sensitive execution stages. Consequently, the synchronization mechanism evolves toward increasingly effective balances between strategic objectives and runtime scheduling requirements.

Similarly, within a telecommunications analytics environment, execution feedback may demonstrate that scheduling feasibility conditions permitting early speculative execution activation substantially reduce recurrence of straggler tasks without compromising partition locality. The policy synchronization processor incorporates these observations into future resource dependency conditions by promoting allocation strategies supportive of proactive speculative execution activities. Over successive analytical workloads, the hierarchical architecture therefore converges toward increasingly coordinated optimization behaviors informed by empirical execution experiences.

Implementation of the present embodiment enables transformation of hierarchical reinforcement learning from a collection of sequential optimization stages into a continuously synchronized decision ecosystem characterized by bidirectional information exchange and adaptive constraint management. Through translation of strategic execution objectives into resource dependency conditions, generation of scheduling feasibility conditions aligned with adaptive resource allocation objectives, transmission of scheduling constraints prior to runtime decision formation, acquisition of execution feedback describing actual scheduling outcomes, and modification of future resource dependency conditions according to observed execution characteristics, the policy synchronization processor establishes a closed-loop coordination mechanism spanning all levels of the reinforcement learning hierarchy. The resulting distributed query execution system demonstrates improved consistency among planning, resource management, and scheduling activities, reduced occurrence of conflicting optimization directives, enhanced adaptability to changing execution environments, and increased capability to sustain efficient execution of complex analytical workloads within Apache Spark infrastructures characterized by heterogeneous resources and dynamic workload conditions.

In an embodiment, the policy adaptation processor is further configured to selectively perform the online reinforcement learning updates by identifying execution events corresponding to changes in cluster topology, workload composition, resource contention conditions, or execution failure occurrences, segmenting execution histories into event-specific state transition sequences associated with the identified execution events, assigning differentiated update priorities to the event-specific state transition sequences according to magnitudes of performance deviations observed following occurrence of the execution events, and updating reinforcement learning policies associated with the first reinforcement learning processor, the second reinforcement learning processor, and the third reinforcement learning processor according to the differentiated update priorities.

Here is the detailed enablement and support description corresponding to the above embodiment:

In an embodiment, the policy adaptation processor is configured to selectively perform online reinforcement learning updates during active execution of distributed analytical queries by continuously monitoring execution events indicative of substantial deviations from previously observed operating conditions within the Apache Spark environment. In contrast to conventional reinforcement learning systems that update policies only after completion of entire execution episodes or according to predetermined training schedules, the present embodiment enables immediate policy refinement responsive to significant changes occurring during runtime operation. Such an adaptive approach allows the hierarchical reinforcement learning architecture to maintain decision relevance despite fluctuations in cluster infrastructure characteristics, evolving workload patterns, transient resource constraints, and unexpected execution failures. As a consequence, the reinforcement learning policies governing strategic planning, adaptive resource allocation, and runtime scheduling remain synchronized with the actual state of the distributed execution environment.

During execution of analytical workloads, the policy adaptation processor continuously receives telemetry observations, execution feedback records, scheduling outcomes, resource utilization indicators, and cluster state representations generated by the telemetry acquisition unit, reward determination processor, and policy synchronization processor. The processor evaluates the incoming information to identify execution events corresponding to changes in cluster topology, workload composition, resource contention conditions, or execution failure occurrences. The identified execution events represent circumstances in which previously established reinforcement learning policies may no longer reflect optimal decision-making behavior due to alterations in the underlying execution environment.

Cluster topology changes are detected through analysis of executor registration activities, heartbeat patterns, node availability records, and resource inventory updates collected from the distributed monitoring processors. Such changes may arise due to dynamic scaling operations performed within cloud infrastructures, introduction of newly provisioned executor nodes, retirement of existing computational resources, maintenance activities affecting subsets of executor populations, or temporary disconnections caused by communication disruptions. For example, a financial institution executing overnight risk assessment workloads may expand the available executor population during periods of elevated computational demand. The policy adaptation processor identifies the resulting changes in cluster topology and recognizes that reinforcement learning policies trained under smaller executor configurations may require immediate refinement to exploit the newly available computational resources effectively.

The policy adaptation processor further identifies execution events corresponding to changes in workload composition. Workload composition changes may occur when the structural characteristics of incoming analytical queries differ substantially from previously encountered workloads. Such changes may include emergence of additional execution stages, introduction of novel combinations of join operations and aggregation procedures, alterations in partition distributions, shifts in data locality relationships, or increases in the prevalence of shuffle-intensive computational activities. For instance, an electronic commerce platform may transition from routine recommendation analytics toward large-scale promotional forecasting workloads during seasonal campaigns. The workload characterization processor captures the modified execution graph structures associated with the new analytical requirements, and the policy adaptation processor subsequently recognizes the corresponding changes in workload composition as candidate triggers for online reinforcement learning updates.

Resource contention conditions constitute an additional category of execution events monitored by the policy adaptation processor. Such conditions are identified through evaluation of processor queue lengths, executor utilization disparities, memory pressure indicators, cache reservation conflicts, storage input-output waiting durations, and network congestion measurements acquired through the telemetry acquisition unit. Resource contention may emerge gradually due to increasing workload intensity or abruptly due to concurrent execution of unrelated applications competing for shared infrastructure resources. For example, within a healthcare analytics environment supporting simultaneous diagnostic inference activities and epidemiological modeling workloads, the policy adaptation processor may observe persistent increases in processor queue lengths accompanied by elevated task waiting durations across multiple execution stages. These observations indicate that reinforcement learning policies governing executor allocation and scheduling decisions should be updated to accommodate the changing resource landscape.

Execution failure occurrences are similarly identified as critical events warranting immediate policy adaptation. Failure occurrences may include executor termination events, repeated task retry sequences, communication interruptions among executor populations, corruption of intermediate execution states, or inability of designated executor nodes to complete assigned computational activities within acceptable execution intervals. Consider a telecommunications analytics deployment in which executor nodes responsible for processing subscriber usage records experience repeated network interruptions resulting in elevated task failure rates. The policy adaptation processor detects the recurring failure patterns and initiates online reinforcement learning updates intended to improve future executor selection, speculative execution initiation, and workload migration decisions.

Following identification of the relevant execution events, the policy adaptation processor segments execution histories into event-specific state transition sequences associated with the identified execution events. Rather than treating the entirety of accumulated execution telemetry as a homogeneous collection of experiences, the processor isolates portions of the execution histories directly related to the operational circumstances surrounding the detected events. Each state transition sequence therefore captures the progression of system states preceding, during, and following the occurrence of a specific execution event category.

For example, in the case of a cluster topology change involving introduction of additional executor nodes, the segmented state transition sequence may begin with cluster state representations corresponding to the pre-expansion configuration, continue through resource allocation decisions implemented during the expansion process, and conclude with execution outcomes observed after integration of the newly available resources. Similarly, for resource contention events, the segmented sequence may include state observations describing initially balanced cluster conditions, transitions reflecting gradual escalation of contention indicators, adaptive scheduling actions undertaken by the third reinforcement learning processor, and resulting task completion behaviors following implementation of corrective measures.

The segmentation process preserves contextual relationships between execution events and the decision trajectories generated by the hierarchical reinforcement learning processors. Consequently, policy updates become informed by the specific operational circumstances in which the experiences occurred rather than by unrelated execution histories exhibiting fundamentally different characteristics. Such event-specific segmentation enables the reinforcement learning architecture to develop specialized responses tailored to recurring execution phenomena encountered within the distributed computing environment.

The policy adaptation processor subsequently assigns differentiated update priorities to the event-specific state transition sequences according to magnitudes of performance deviations observed following occurrence of the identified execution events. Performance deviations represent differences between expected execution behaviors predicted under prevailing reinforcement learning policies and actual execution outcomes observed after the events transpired. The magnitudes of these deviations provide insight into the extent to which existing policies remain suitable under altered operating conditions.

Execution events associated with substantial performance degradation receive elevated update priorities because they indicate deficiencies requiring immediate policy correction. For instance, if introduction of new executor nodes results in unexpectedly severe workload imbalance due to outdated resource allocation strategies, the corresponding state transition sequences receive high update priorities to accelerate learning of more effective allocation behaviors. Conversely, events resulting in only modest deviations from expected performance characteristics may receive comparatively lower update priorities because existing policies continue to operate satisfactorily despite the observed environmental changes.

As an illustrative example, consider a recommendation analytics application experiencing a sudden surge in user activity during a promotional campaign. The resulting increase in workload intensity generates pronounced processor utilization disparities, escalating task waiting durations, and repeated emergence of straggler tasks. The policy adaptation processor identifies the resource contention event, segments the associated execution histories, and assigns elevated update priorities to the resulting state transition sequences because the observed scheduling effectiveness indicators deviate substantially from historical norms. The subsequent online reinforcement learning updates therefore focus attention upon the execution experiences most relevant to mitigation of the emerging performance challenges.

The differentiated update priorities are utilized during refinement of reinforcement learning policies associated with the first reinforcement learning processor, the second reinforcement learning processor, and the third reinforcement learning processor. State transition sequences possessing elevated priorities contribute more substantially toward policy adjustments than sequences corresponding to comparatively minor performance deviations. As a result, the hierarchical reinforcement learning architecture allocates learning effort proportionally according to the operational significance of observed execution events.

Policies associated with the first reinforcement learning processor may therefore evolve to generate alternative execution graph decomposition arrangements more suitable for altered workload compositions. Policies governing the second reinforcement learning processor may adapt to improve executor redistribution behaviors and memory reservation strategies in response to emerging resource contention conditions. Similarly, policies associated with the third reinforcement learning processor may refine speculative execution initiation criteria, workload migration procedures, and task placement preferences following repeated execution failure occurrences or scheduling inefficiencies.

For instance, within a fraud detection environment processing rapidly evolving transaction streams, repeated execution failures affecting specific executor populations may lead the third reinforcement learning processor to increasingly favor proactive speculative execution and earlier workload migration initiation. Simultaneously, the second reinforcement learning processor may modify resource allocation behaviors to avoid excessive concentration of high-risk workloads upon historically unstable executor groups. The first reinforcement learning processor may further revise strategic decomposition arrangements to reduce dependency propagation through failure-prone execution pathways.

The selective online reinforcement learning update process described herein enables the hierarchical reinforcement learning architecture to adapt continuously to the dynamic conditions characterizing distributed analytical processing environments. Through identification of execution events corresponding to topology changes, workload evolution, resource contention, and execution failures; segmentation of execution histories into event-specific state transition sequences; assignment of differentiated update priorities according to observed performance deviations; and targeted refinement of policies governing strategic planning, resource allocation, and scheduling activities, the policy adaptation processor facilitates rapid incorporation of newly acquired operational knowledge into the decision-making framework. The resulting distributed query execution system demonstrates enhanced resilience against environmental fluctuations, improved responsiveness to emerging execution challenges, increased stability of reinforcement learning convergence behavior, and sustained effectiveness of adaptive optimization policies throughout prolonged operation within heterogeneous Apache Spark infrastructures.

In various embodiments, the system may be implemented as a physically realizable query execution control device operatively coupled to a distributed computing infrastructure comprising a plurality of executor nodes, communication interfaces, and non-transitory storage resources. The query intake unit may comprise one or more hardware communication interfaces implemented using network interface circuitry configured to receive analytical queries transmitted from client devices, distributed computing coordinators, application interfaces, or upstream processing systems through wired or wireless communication channels. The telemetry acquisition unit may comprise dedicated monitoring processors, sensor interfaces, network interface controllers, timing circuits, and data acquisition circuitry configured to periodically collect runtime operational parameters from the plurality of executor nodes. Such runtime operational parameters may include processor utilization measurements generated by processor performance counters, memory occupancy values generated through memory management hardware, cache utilization statistics obtained through cache monitoring circuitry, storage access characteristics obtained through storage controller interfaces, network transmission information generated by communication adapters, and executor availability information obtained through heartbeat monitoring circuits. The workload characterization processor may comprise one or more general-purpose processors, multicore processing units, digital signal processors, application-specific integrated circuits, field-programmable logic devices, or combinations thereof, communicatively coupled to non-transitory memory elements storing executable instructions configured to transform logical execution plans and physical execution plans into graph-based workload representations and to extract execution descriptors associated with analytical queries.

The hierarchical decision processor may be implemented using one or more physical processing devices interconnected through system buses and configured to execute reinforcement learning computations using processor-executable instructions stored within non-transitory computer-readable memory devices. The first reinforcement learning processor, second reinforcement learning processor, and third reinforcement learning processor may be instantiated as logically distinct processing regions executing upon dedicated processor cores, distributed processor clusters, reconfigurable hardware fabrics, or separate computational units interconnected through high-speed communication pathways. Each reinforcement learning processor may access volatile memory resources for maintaining active state representations and may further utilize persistent memory devices for retaining learned policy parameters, execution histories, and decision records. The policy synchronization processor may comprise dedicated coordination circuitry implemented using one or more processing units configured to exchange constraint information, execution objectives, and feedback signals among the reinforcement learning processors through shared memory architectures, interprocessor communication interfaces, or message-passing mechanisms implemented within the hardware environment. The reward determination processor may comprise arithmetic processing circuitry configured to evaluate execution outcomes using telemetry measurements stored within memory resources and to generate reward values associated with strategic planning decisions, resource allocation decisions, and scheduling decisions.

The policy adaptation processor may comprise one or more processing devices configured to retrieve historical execution records from persistent storage devices, perform policy update computations using the reward values generated by the reward determination processor, and store revised policy parameters within non-transitory memory elements accessible by the reinforcement learning processors. The telemetry storage unit may comprise one or more non-transitory storage devices including solid-state memory devices, magnetic storage media, optical storage media, phase-change memory elements, resistive memory devices, or combinations thereof, configured to maintain workload representations, cluster state representations, execution histories, policy evolution records, and reward histories associated with distributed query execution activities. The execution interface processor may comprise network communication circuitry, interface controllers, protocol processing units, and input-output interfaces configured to transmit execution scheduling directives toward the distributed computing environment and receive execution acknowledgements, telemetry updates, and task status notifications generated by executor nodes participating in distributed query execution.

The plurality of executor nodes may each comprise one or more physical processors, volatile memory devices, cache memories, storage controllers, communication adapters, and local storage devices configured to execute distributed processing tasks assigned through the execution interface processor. The distributed monitoring processors associated with the executor nodes may comprise hardware-assisted monitoring circuitry configured to collect processor performance information, memory utilization measurements, storage activity indicators, network communication statistics, and execution progress data during operation of the executor nodes. Communication among the query execution control device, the executor nodes, and the distributed monitoring processors may occur through one or more communication networks comprising physical transmission media, switching devices, routing devices, and interface controllers supporting exchange of execution directives, telemetry measurements, and synchronization information. The various processing units described herein may be implemented using a single integrated computing apparatus or may alternatively be distributed across multiple interconnected hardware devices operating cooperatively within a distributed computing environment, provided that the constituent hardware elements collectively perform the described functionalities.

The memory resources utilized throughout the system may comprise combinations of volatile memory technologies configured to temporarily store active execution states, intermediate computational variables, scheduling directives, and runtime telemetry information, together with non-volatile memory technologies configured to persist workload histories, learned policy representations, dependency information, and execution records across power cycles. Interconnection among the processors, memory resources, storage units, communication interfaces, and monitoring circuitry may be achieved through one or more system buses, communication fabrics, switching architectures, or dedicated interconnect pathways enabling transfer of data, control signals, execution directives, and synchronization information among the constituent hardware components. Accordingly, each functional element described herein corresponds to a physically realizable hardware implementation comprising one or more processors, memory devices, communication interfaces, storage resources, monitoring circuits, or combinations thereof operating cooperatively to facilitate adaptive distributed query execution within a distributed computing infrastructure.

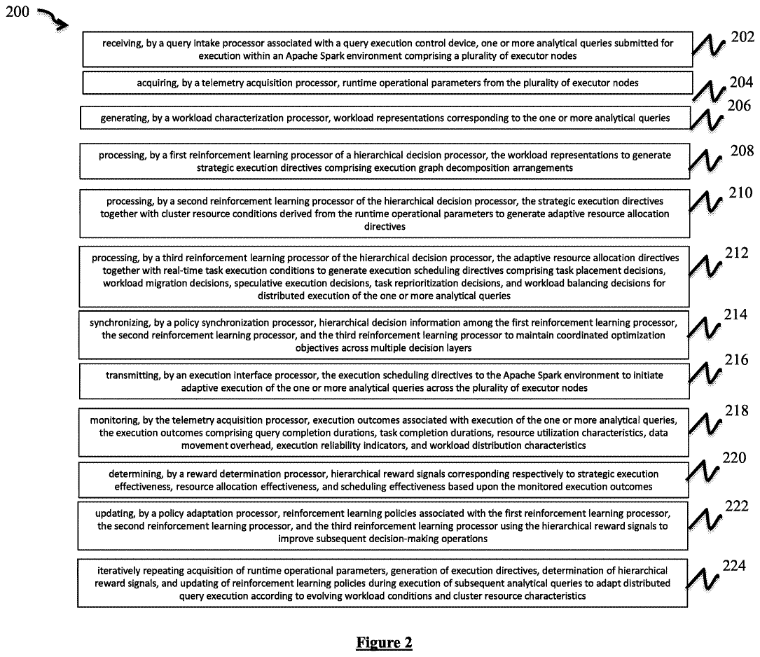

Referring to FIG. 2, the flow chart for a method for adaptive distributed query execution in an Apache Spark environment using artificial intelligence based three level hierarchical reinforcement learning is illustrated. the method 200 comprises:

At step 202, the method 200 includes receiving, by a query intake processor associated with a query execution control device, one or more analytical queries submitted for execution within an Apache Spark environment comprising a plurality of executor nodes;

At step 204, the method 200 includes acquiring, by a telemetry acquisition processor, runtime operational parameters from the plurality of executor nodes, the runtime operational parameters comprising processor utilization values, memory occupancy values, cache utilization values, network transmission characteristics, storage access characteristics, task execution statistics, data locality indicators, and node availability conditions;

At step 206, the method 200 includes generating, by a workload characterization processor, workload representations corresponding to the one or more analytical queries by extracting query execution graph structures, execution stage dependencies, partition characteristics, shuffle requirements, aggregation operation attributes, join operation attributes, and historical execution signatures associated with the one or more analytical queries;

At step 208, the method 200 includes processing, by a first reinforcement learning processor of a hierarchical decision processor, the workload representations to generate strategic execution directives comprising execution graph decomposition arrangements, partition generation configurations, join implementation selections, execution path selections, and stage dependency ordering information for the one or more analytical queries;

At step 210, the method 200 includes processing, by a second reinforcement learning processor of the hierarchical decision processor, the strategic execution directives together with cluster resource conditions derived from the runtime operational parameters to generate adaptive resource allocation directives comprising executor allocation instructions, processor assignment instructions, memory reservation instructions, cache distribution instructions, and storage utilization instructions associated with execution of the one or more analytical queries;

At step 212, the method 200 includes processing, by a third reinforcement learning processor of the hierarchical decision processor, the adaptive resource allocation directives together with real-time task execution conditions to generate execution scheduling directives comprising task placement decisions, workload migration decisions, speculative execution decisions, task reprioritization decisions, and workload balancing decisions for distributed execution of the one or more analytical queries;

At step 214, the method 200 includes synchronizing, by a policy synchronization processor, hierarchical decision information among the first reinforcement learning processor, the second reinforcement learning processor, and the third reinforcement learning processor to maintain coordinated optimization objectives across multiple decision layers;

At step 216, the method 200 includes transmitting, by an execution interface processor, the execution scheduling directives to the Apache Spark environment to initiate adaptive execution of the one or more analytical queries across the plurality of executor nodes;

At step 218, the method 200 includes monitoring, by the telemetry acquisition processor, execution outcomes associated with execution of the one or more analytical queries, the execution outcomes comprising query completion durations, task completion durations, resource utilization characteristics, data movement overhead, execution reliability indicators, and workload distribution characteristics;

At step 220, the method 200 includes determining, by a reward determination processor, hierarchical reward signals corresponding respectively to strategic execution effectiveness, resource allocation effectiveness, and scheduling effectiveness based upon the monitored execution outcomes;

At step 222, the method 200 includes updating, by a policy adaptation processor, reinforcement learning policies associated with the first reinforcement learning processor, the second reinforcement learning processor, and the third reinforcement learning processor using the hierarchical reward signals to improve subsequent decision-making operations; and

At step 224, the method 200 includes iteratively repeating acquisition of runtime operational parameters, generation of execution directives, determination of hierarchical reward signals, and updating of reinforcement learning policies during execution of subsequent analytical queries to adapt distributed query execution according to evolving workload conditions and cluster resource characteristics.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A system for adaptive distributed query execution in an Apache Spark environment using artificial intelligence based three level hierarchical reinforcement learning, the system comprising:
a query intake unit configured to receive one or more distributed analytical queries originating from an Apache Spark driver associated with a plurality of executor nodes;
a telemetry acquisition unit operatively coupled to the plurality of executor nodes and configured to continuously collect runtime operational parameters comprising processor utilization values, memory occupancy values, cache utilization values, network transmission characteristics, storage access characteristics, task execution statistics, data locality indicators, and node availability conditions;
a workload characterization processor communicatively coupled to the query intake unit and configured to generate workload representations by extracting query execution graph structures, stage dependencies, partition characteristics, shuffle requirements, aggregation operations, join operation attributes, and historical execution signatures corresponding to the received analytical queries;
a hierarchical decision processor comprising a first reinforcement learning processor, a second reinforcement learning processor, and a third reinforcement learning processor arranged in a hierarchical configuration;
wherein the first reinforcement learning processor is configured to receive the workload representations and generate strategic execution directives comprising execution graph decomposition arrangements, partition generation configurations, join implementation selections, and stage dependency ordering information;
wherein the second reinforcement learning processor is configured to receive the strategic execution directives together with cluster resource conditions obtained from the telemetry acquisition unit and generate adaptive resource allocation directives comprising executor allocation instructions, processor assignment instructions, memory reservation instructions, cache distribution instructions, and storage utilization instructions;
wherein the third reinforcement learning processor is configured to receive the adaptive resource allocation directives and real-time task execution conditions and generate execution scheduling directives comprising task placement decisions, workload migration decisions, speculative execution decisions, and task reprioritization decisions;
a policy synchronization processor configured to exchange hierarchical decision information among the first reinforcement learning processor, the second reinforcement learning processor, and the third reinforcement learning processor to maintain coordinated optimization objectives across different decision layers;
a reward determination processor configured to generate hierarchical reward signals corresponding to execution latency, resource utilization efficiency, task completion effectiveness, data movement overhead, and execution reliability associated with distributed query execution outcomes;
a policy adaptation processor configured to iteratively update reinforcement learning policies associated with the first reinforcement learning processor, the second reinforcement learning processor, and the third reinforcement learning processor using the hierarchical reward signals; and
an execution interface processor configured to transmit the execution scheduling directives to the Apache Spark environment for controlling adaptive execution of the analytical queries across the plurality of executor nodes, wherein the reward determination processor is configured to generate a first hierarchical reward signal corresponding to strategic execution effectiveness determined according to reductions in execution stage dependencies and reductions in shuffle operation frequencies, generate a second hierarchical reward signal corresponding to resource allocation effectiveness determined according to processor utilization balance, memory utilization efficiency, and cache utilization characteristics, and generate a third hierarchical reward signal corresponding to scheduling effectiveness determined according to reductions in task waiting durations, reductions in straggler task occurrences, and improvements in workload distribution uniformity, and wherein the policy synchronization processor is configured to perform hierarchical constraint propagation by transmitting strategic execution objectives generated by the first reinforcement learning processor to the second reinforcement learning processor, transmitting adaptive resource allocation objectives generated by the second reinforcement learning processor to the third reinforcement learning processor, and transmitting execution feedback generated by the third reinforcement learning processor to the first reinforcement learning processor, thereby maintaining consistency among decision policies associated with different hierarchical levels.

2. The system of claim 1, wherein the workload characterization processor is further configured to generate graph-based workload representations by converting logical query plans and physical execution plans into node-edge dependency structures, each node representing a computational operation selected from filtering operations, projection operations, aggregation operations, sorting operations, and join operations, and each edge representing execution dependencies among the computational operations, thereby enabling the first reinforcement learning processor to generate strategic execution directives based upon execution graph topology characteristics, and wherein the telemetry acquisition unit further comprises a plurality of distributed monitoring processors respectively associated with the plurality of executor nodes, each distributed monitoring processor being configured to periodically capture processor queue lengths, memory page fault occurrences, cache hit ratios, disk input and output waiting durations, network packet retransmission characteristics, executor heartbeat intervals, and task retry events, and wherein the captured runtime operational parameters are transformed into multidimensional cluster state representations prior to transmission to the hierarchical decision processor.

3. The system of claim 1, wherein the first reinforcement learning processor comprises a strategic policy processor configured to generate alternative execution graph decomposition arrangements by selectively controlling broadcast join execution, shuffle-based join execution, partition coalescing operations, partition expansion operations, stage boundary definitions, and execution path selection, based upon historical execution outcomes associated with substantially similar workload representations stored within a telemetry storage unit, and wherein the second reinforcement learning processor is configured to generate executor allocation instructions by determining a quantity of executors assigned to individual execution stages, allocating memory capacities to respective executors according to predicted intermediate data volumes, assigning processing resources according to anticipated computational intensity, and reserving cache resources according to estimated data reuse characteristics associated with the strategic execution directives generated by the first reinforcement learning processor.

4. The system of claim 1, wherein the third reinforcement learning processor is configured to identify execution anomalies during runtime operation by detecting execution duration deviations exceeding dynamically learned thresholds, identifying data skew conditions associated with specific partitions, determining straggler tasks exhibiting completion characteristics different from peer tasks within a common execution stage, and generating workload migration decisions and speculative execution decisions responsive to the identified execution anomalies, and further comprising a telemetry storage unit configured to maintain historical records comprising workload representations, cluster state representations, strategic execution directives, adaptive resource allocation directives, execution scheduling directives, hierarchical reward signals, and policy adaptation outcomes, wherein the policy adaptation processor is configured to retrieve the historical records for performing experience replay operations to improve convergence characteristics associated with reinforcement learning policy updates.

5. The system of claim 1, wherein the policy adaptation processor is configured to selectively perform online reinforcement learning updates during active query execution and offline reinforcement learning updates using previously stored execution histories, the online reinforcement learning updates being initiated in response to changes in cluster topology, workload composition, resource contention conditions, or execution failure occurrences detected by the telemetry acquisition unit.

6. The system of claim 2, wherein the workload characterization processor is further configured to construct the graph-based workload representations by assigning, to each node of the node-edge dependency structures, an execution context descriptor comprising a transformation lineage identifier, an estimated intermediate dataset generation indicator, a partition affinity indicator, an execution stage membership indicator, and an operator interaction indicator, and wherein the workload characterization processor is further configured to recursively traverse parent-child dependencies within the node-edge dependency structures to identify propagation paths associated with shuffle-inducing operations, aggregate the identified propagation paths into stage-level dependency chains, determine dependency criticality scores corresponding to the stage-level dependency chains according to a quantity of downstream operations affected by execution delays occurring at individual nodes, and transmit the dependency criticality scores to the first reinforcement learning processor for prioritizing strategic execution directives associated with execution graph decomposition arrangements.

7. The system of claim 2, wherein the telemetry acquisition unit is further configured to temporally align processor queue lengths, memory page fault occurrences, cache hit ratios, disk input and output waiting durations, network packet retransmission characteristics, executor heartbeat intervals, and task retry events collected from the plurality of distributed monitoring processors by assigning collection timestamps to respective runtime operational parameters, generating synchronized observation windows comprising telemetry measurements captured during common execution intervals, determining inter-node resource imbalance conditions by comparing synchronized observation windows corresponding to different executor nodes participating in a common execution stage, and generating cluster state transition representations identifying variations in resource conditions occurring between successive synchronized observation windows for transmission to the hierarchical decision processor.

8. The system of claim 3, wherein the first reinforcement learning processor is further configured to generate the alternative execution graph decomposition arrangements by iteratively evaluating candidate stage boundary definitions against workload representations corresponding to received analytical queries, identifying execution stages exhibiting repeated shuffle dependencies across multiple execution paths, separating the identified execution stages into independently executable graph segments, determining whether intermediate outputs generated by upstream graph segments satisfy predetermined partition affinity conditions associated with downstream graph segments, and selectively modifying partition generation configurations prior to issuance of strategic execution directives to reduce cross-stage redistribution of intermediate datasets during distributed query execution.

9. The system of claim 3, wherein the first reinforcement learning processor is further configured to selectively control broadcast join execution and shuffle-based join execution by identifying join nodes within the workload representations, determining for each join node a degree of partition alignment between participating datasets based upon partition identifiers extracted from the workload representations, evaluating whether existing partition boundaries satisfy execution locality requirements associated with the join nodes, generating partition preservation directives responsive to satisfaction of the execution locality requirements, and alternatively generating repartitioning directives specifying partition transformation sequences to be executed before initiation of corresponding join operations.

10. The system of claim 3, wherein the second reinforcement learning processor is further configured to generate the executor allocation instructions by establishing execution-stage-specific resource demand profiles derived from predicted intermediate data volumes and anticipated computational intensity values, determining executor redistribution opportunities by identifying execution stages exhibiting resource underutilization simultaneously with execution stages exhibiting resource contention conditions, generating staged executor reassignment directives specifying executor migration sequences among the execution stages, and coordinating implementation of the staged executor reassignment directives according to dependency ordering information generated by the first reinforcement learning processor.

11. The system of claim 3, wherein the second reinforcement learning processor is further configured to generate the cache distribution instructions by identifying execution stages associated with repetitive access to intermediate datasets, determining whether the intermediate datasets are referenced by multiple downstream execution stages, assigning cache persistence priorities to the intermediate datasets according to frequencies of downstream references, dynamically modifying cache reservation instructions responsive to changes in execution progress across the execution stages, and releasing previously reserved cache resources upon determining completion of all downstream execution stages dependent upon the corresponding intermediate datasets.

12. The system of claim 11, wherein the third reinforcement learning processor is further configured to identify the data skew conditions associated with specific partitions by comparing task execution durations corresponding to partitions processed within a common execution stage, determining partition processing asymmetry values based upon deviations among the task execution durations, identifying skew-contributing partitions exhibiting partition processing asymmetry values exceeding dynamically updated reference ranges, generating partition redistribution directives specifying subdivision of the skew-contributing partitions into replacement partition groups, and issuing updated execution scheduling directives for assigning the replacement partition groups to different executor nodes participating in the common execution stage, and wherein the third reinforcement learning processor is further configured to generate the speculative execution decisions by maintaining execution progress indicators corresponding to tasks associated with a common execution stage, determining expected task completion trajectories according to execution progress indicators of previously completed peer tasks within the common execution stage, identifying candidate tasks exhibiting divergence from the expected task completion trajectories, selecting alternative executor nodes satisfying resource availability conditions derived from the adaptive resource allocation directives, and initiating duplicate execution scheduling directives for the candidate tasks while preserving execution state consistency among concurrently executing task instances.

13. The system of claim 12, wherein the telemetry storage unit is further configured to organize the historical records into workload similarity groups based upon execution graph topology characteristics, partition characteristics, shuffle requirements, aggregation operation patterns, and join operation attributes extracted from the workload representations, and wherein the policy adaptation processor is further configured to retrieve experience replay samples from different workload similarity groups according to predetermined sampling proportions that maintain representation of distinct execution conditions encountered during prior distributed query executions.

14. The system of claim 12, wherein the reward determination processor is further configured to generate the first hierarchical reward signal by determining changes in execution graph dependency depths between successive strategic execution directives generated for substantially similar workload representations, calculating variations in quantities of shuffle-inducing execution paths occurring within corresponding node-edge dependency structures, assigning strategic reward values according to combined effects of the changes in execution graph dependency depths and the variations in quantities of shuffle-inducing execution paths, and transmitting the strategic reward values to the policy adaptation processor for updating policies associated with the first reinforcement learning processor, and wherein the reward determination processor is further configured to generate the second hierarchical reward signal by identifying processor utilization disparities among executor nodes participating in common execution stages, determining memory reservation inefficiencies according to relationships between allocated memory capacities and observed memory occupancy values, identifying cache reservation mismatches according to frequencies of access to reserved datasets, generating resource allocation effectiveness indicators from the processor utilization disparities, the memory reservation inefficiencies, and the cache reservation mismatches, and transmitting the resource allocation effectiveness indicators to the policy adaptation processor for updating policies associated with the second reinforcement learning processor.

15. The system of claim 12, wherein the reward determination processor is further configured to generate the third hierarchical reward signal by determining task waiting durations associated with tasks scheduled during common execution intervals, identifying execution stages exhibiting repeated straggler task occurrences, calculating workload distribution non-uniformity values according to disparities in task completion frequencies among executor nodes, generating scheduling effectiveness indicators from the task waiting durations, the repeated straggler task occurrences, and the workload distribution non-uniformity values, and transmitting the scheduling effectiveness indicators to the policy adaptation processor for updating policies associated with the third reinforcement learning processor, and wherein the policy synchronization processor is further configured to perform hierarchical constraint propagation by translating strategic execution objectives received from the first reinforcement learning processor into resource dependency conditions governing operation of the second reinforcement learning processor, generating scheduling feasibility conditions according to adaptive resource allocation objectives received from the second reinforcement learning processor, transmitting the scheduling feasibility conditions to the third reinforcement learning processor prior to generation of execution scheduling directives, receiving execution feedback corresponding to implemented execution scheduling directives, and modifying subsequently transmitted resource dependency conditions according to the received execution feedback.

16. The system of claim 13, wherein the policy adaptation processor is further configured to selectively perform the online reinforcement learning updates by identifying execution events corresponding to changes in cluster topology, workload composition, resource contention conditions, or execution failure occurrences, segmenting execution histories into event-specific state transition sequences associated with the identified execution events, assigning differentiated update priorities to the event-specific state transition sequences according to magnitudes of performance deviations observed following occurrence of the execution events, and updating reinforcement learning policies associated with the first reinforcement learning processor, the second reinforcement learning processor, and the third reinforcement learning processor according to the differentiated update priorities.
